(19) United States
(12) Patent Application Publication
(10) Pub. No.: US 2026/0077593 A1
(43) Pub. Date: Mar. 19, 2026

(54) LIQUID EJECTING HEAD

(71) Applicant: SEIKO EPSON CORPORATION, Tokyo (JP)

(72) Inventors: Yu HASEGAWA, SHIOJIRI-SHI (JP); Hiroaki OKUI, AZUMINO-SHI (JP)

(21) Appl. No.: 19/324,226

(22) Filed: Sep. 10, 2025

(30) Foreign Application Priority Data
Sep. 13, 2024 (JP) 2024-158959

(51) Int. Cl. B41J 2/145; B41J 2/16; B41J 2/175

(52) U.S. Cl. CPC B41J 2/145; B41J 2/161; B41J 2/1623; B41J 2/175

(57) ABSTRACT

A liquid ejecting head includes a fixing plate, a holder stacked in a first direction on the fixing plate and having a first surface, and an adhesive that adheres the fixing plate to the first surface, in which the first surface has an adhesive region in contact with the adhesive, a first line segment in the adhesive region is longer than a second line segment in the adhesive region, a region of the first surface that overlaps the first line segment has first adhesive regions and a first recess, and a region of the adhesive region that overlaps the second line segment has a distance in the first direction from the fixing plate that is greater than a distance in the first direction between the fixing plate and the first adhesive region.

The present application is based on, and claims priority from JP Application Serial Number 2024-158959, filed Sep. 13, 2024, the disclosure of which is hereby incorporated by reference herein in its entirety.

### BACKGROUND

### 1. Technical Field

The present disclosure relates to a liquid ejecting head that ejects a liquid from a nozzle.

### 2. Related Art

JP-A-2023-172073 discloses that in a liquid ejecting head including a head chip that ejects a liquid, a holder unit that accommodates and supports a plurality of head chips, and a fixing plate for fixing the plurality of head chips to the holder unit, the holder unit and the fixing plate are fixed with an adhesive.

In the liquid ejecting head as described above, it is desirable to suppress excess adhesive from overflowing outside the adhesive region where the holder unit and the fixing plate are adhered. Therefore, by providing a recess in the holder unit or the fixing plate, the excess adhesive can be made to flow into the recess, thereby suppressing the adhesive from overflowing.

However, in some cases, a portion of the holder unit or the fixing plate has a narrow width of the adhesive region, and no recess is provided for causing excess adhesive to flow therein. In such a case, instead of providing a recess, the adhesive can also be suppressed from overflowing by increasing the distance between the fixing plate and the holder unit. However, since the thickness of the adhesive increases, there is a concern that the adhesive strength may decrease.

Therefore, when a portion of the adhesive region includes a narrow portion, it is desirable to suppress the adhesive from overflowing while suppressing a decrease in strength. These problems arise not only in the adhesion between the fixing plate and the holder unit, but also in the adhesion between other members.

### SUMMARY

According to an aspect of the present disclosure, there is provided a liquid ejecting head including: a first member; a second member stacked in a first direction on the first member and having a first surface; and an adhesive that adheres the first member to the first surface, in which the first surface has an adhesive region in contact with the adhesive, when viewed in the first direction, a first line segment that passes through a first point in the adhesive region and connects end portions of the adhesive region at a shortest distance is longer than a second line segment that passes through a second point different from the first point in the adhesive region and connects the end portions of the adhesive region at the shortest distance, a region of the first surface that overlaps the first line segment in the first direction has first adhesive regions that are portions of the adhesive region and a first recess that is recessed in the first direction further than the first adhesive regions, and a second adhesive region of the adhesive region that overlaps the second line segment in the first direction has a distance in the first direction from the first member that is greater than a distance in the first direction between the first member and the first adhesive region, and does not have a recess whose length in a direction along the second line segment is equal to or greater than a length of the first recess in a direction along the first line segment.

### BRIEF DESCRIPTION OF THE DRAWINGS

FIG. 1 is a schematic view showing a configuration example of a liquid ejecting apparatus according to a first embodiment.

FIG. 2 is a perspective view of a liquid ejecting module having a liquid ejecting head according to the first embodiment.

FIG. 3 is an exploded perspective view of the liquid ejecting head shown in FIG. 2.

FIG. 4 is an exploded perspective view of a head chip of the liquid ejecting head.

FIG. 5 is a cross-sectional view taken along line V-V in FIG. 4.

FIG. 6 is a plan view of a holder of the liquid ejecting heads shown in FIG. 2.

FIG. 7 is an enlarged view of an area within a frame line VII in FIG. 6.

FIG. 8 is an enlarged view of an area within a frame line VIII in FIG. 7.

FIG. 9 is an enlarged view of an area within a frame line IX in FIG. 7.

FIG. 10 is a cross-sectional view taken along a first line segment in FIG. 7.

FIG. 11 is a cross-sectional view taken along a second line segment in FIG. 7.

FIG. 12 is a cross-sectional view taken along a third line segment in FIG. 7.

FIG. 13 is a cross-sectional view taken along line XIII-XIII in FIG. 7.

FIG. 14 is a schematic plan view of a holder of a liquid ejecting head according to a first modification example.

FIG. 15 is a cross-sectional view taken along a first line segment in FIG. 14.

FIG. 16 is a schematic plan view of a holder of a liquid ejecting head according to a second modification example.

FIG. 17 is a cross-sectional view taken along a first line segment in FIG. 16.

FIG. 18 is a schematic plan view of a holder of a liquid ejecting head according to a third modification example.

FIG. 19 is a cross-sectional view taken along a first line segment in FIG. 18.

FIG. 20 is a cross-sectional view of a holder and a fixing plate of a liquid ejecting head according to a fourth modification example.

FIG. 21 is a cross-sectional view of a holder and a fixing plate of a liquid ejecting head according to a fifth modification example.

FIG. 22 is a plan view of a second flow path member of a liquid ejecting head according to a second embodiment.

FIG. 23 is a cross-sectional view taken along line XXIII-XXIII in FIG. 22.

### DESCRIPTION OF EMBODIMENTS

Preferred embodiments according to the present disclosure will be described below with reference to the accompanying drawings. In the drawings, dimensions and scales of each section are appropriately different from the actual ones, and some portions are schematically shown for easy understanding. Further, the scope of the present disclosure is not limited to these forms unless it is stated in the following description that the present disclosure is particularly limited.

Hereinafter, for convenience of description, an X-axis, a Y-axis, and a Z-axis that intersect each other are appropriately used.

One direction along the X-axis is referred to as an X1 direction, and a direction opposite to the X1 direction is referred to as an X2 direction. Similarly, directions opposite to each other along the Y-axis are referred to as a Y1 direction and a Y2 direction. Moreover, directions opposite to each other along the Z-axis are referred to as a Z1 direction and a Z2 direction. Furthermore, when the X1 direction and the X2 direction are not limited, a direction along the X-axis is referred to as an X-axis direction. Similarly, when the Y1 direction and the Y2 direction are not limited, a direction along the Y-axis is referred to as a Y-axis direction, and when the Z1 direction and the Z2 direction are not limited, a direction along the Z-axis is referred to as a Z-axis direction.

Here, typically, the Z-axis is a vertical axis, and the Z2 direction corresponds to a downward direction in the vertical direction. However, the Z-axis does not have to be a vertical axis and may be inclined with respect to the vertical axis. The X-axis, the Y-axis, and the Z-axis are typically orthogonal to each other, but are not limited thereto, and need only intersect each other at, for example, an angle within a range of, for example, 80° or more and 100° or less.

### 1. First Embodiment

### 1-1. Liquid Ejecting Apparatus

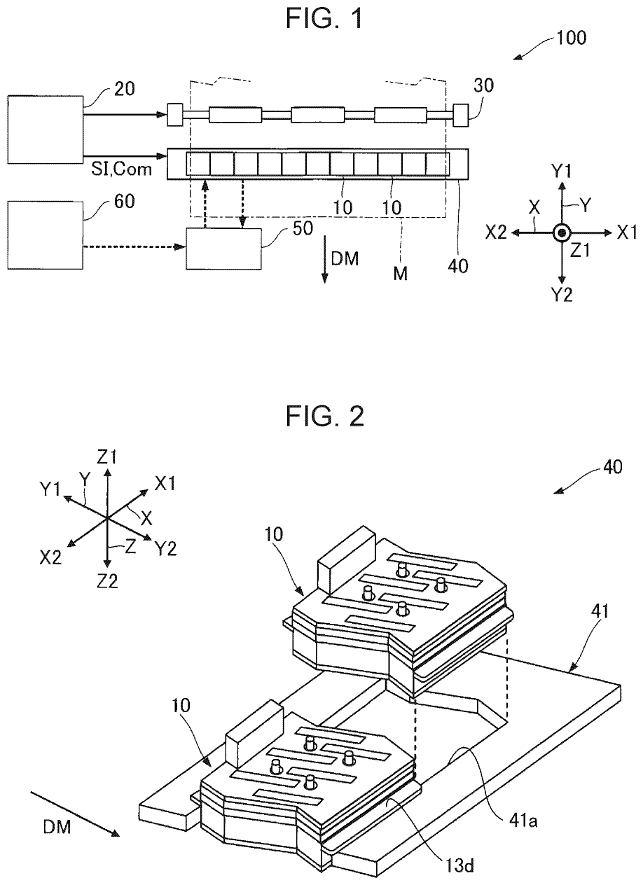

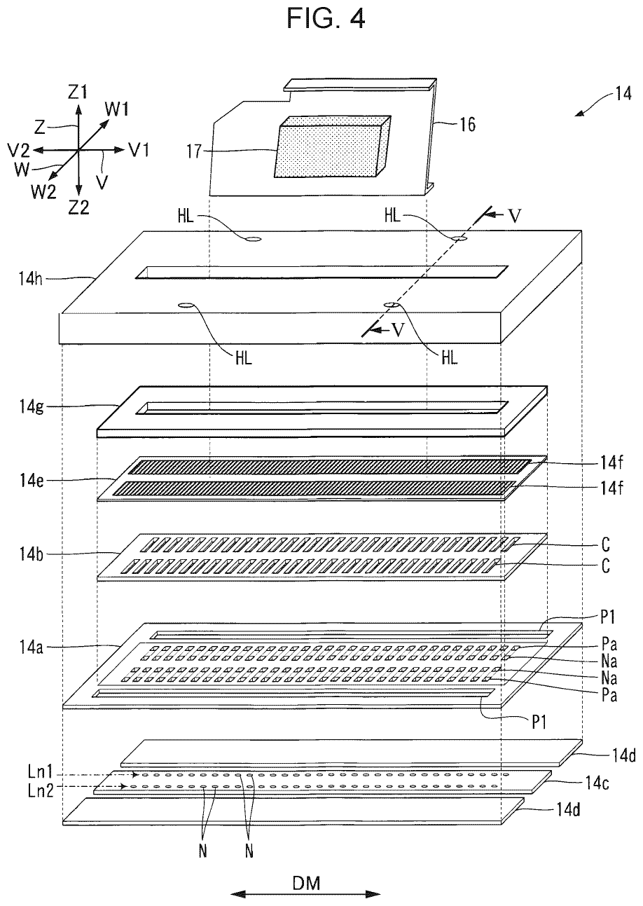

FIG. 1 is a schematic view showing a configuration example of a liquid ejecting apparatus 100 according to an embodiment. The liquid ejecting apparatus 100 is an ink jet type printing apparatus that ejects ink onto a medium M in the form of droplets. Ink is an example of a “liquid”. The liquid ejecting apparatus 100 according to the present embodiment is a so-called line-type printing apparatus in which a plurality of nozzles N (see FIG. 4) that eject ink are distributed across the entire range of the medium M in a width direction. The medium M is typically printing paper. The medium M is not limited to the printing paper, and may be, for example, a printing target having any desired material such as a resin film or fabric.

As shown in FIG. 1, the liquid ejecting apparatus 100 has a liquid storage portion 60, a control unit 20, a transport mechanism 30, a liquid ejecting module 40, and a circulation mechanism 50.

The liquid storage portion 60 is a container that stores ink. Examples of a specific aspect of the liquid storage portion 60 include a cartridge that is attachable to and detachable from the liquid ejecting apparatus 100, a bag-like ink pack formed of a flexible film, and an ink tank that can be replenished with ink. The type of ink stored in the liquid storage portion 60 is optional.

Although not shown, the liquid storage portion 60 according to the present embodiment includes a first liquid container and a second liquid container. The first liquid container stores a first ink. The second liquid container stores a second ink of a different type than the first ink. The first ink and the second ink are, for example, inks with different colors from each other. The first ink and the second ink may be the same type of ink.

The control unit 20 controls an operation of each element of the liquid ejecting apparatus 100. Here, the control unit 20 outputs a control signal SI that controls an ink ejection operation in the liquid ejecting module 40, and a drive signal Com for driving the liquid ejecting module 40. The control unit 20 includes a processing circuit such as a central processing unit (CPU) or a field programmable gate array (FPGA), and a storage circuit such as a semiconductor memory. The storage circuit stores various programs and various types of data. The processing circuit realizes various controls by executing the programs and using the data as appropriate.

The transport mechanism 30 transports the medium M in a direction DM under the control of the control unit 20. The direction DM of the present embodiment is the Y2 direction. In the example shown in FIG. 1, the transport mechanism 30 includes a transport roller that is elongated along the X-axis, and a motor that rotates the transport roller. The transport mechanism 30 is not limited to the configuration using the transport roller, and may be configured to use, for example, a drum or an endless belt that transports the medium M in a state of being attracted to an outer peripheral surface by electrostatic force or the like.

The liquid ejecting module 40 ejects ink, which is supplied from the liquid storage portion 60 via the circulation mechanism 50, from each of the plurality of nozzles N onto the medium M in the Z2 direction under the control of the control unit 20. The liquid ejecting module 40 is an elongated line head extending in the X-axis direction and has a plurality of liquid ejecting heads 10 disposed such that a plurality of nozzles N are distributed over the entire range of the medium M in the X-axis direction. By ejecting ink from the plurality of liquid ejecting heads 10 in parallel with the transport of the medium M by the transport mechanism 30, an image is formed at a surface of the medium M by the ink. In addition, the liquid ejecting module 40 may be an elongated line head extending in the X-axis direction, by being composed of only a single liquid ejecting head 10 disposed such that a plurality of nozzles N are distributed over the entire range of the medium M in the X-axis direction.

In the example shown in FIG. 1, the liquid storage portion 60 is coupled to the liquid ejecting module 40 via the circulation mechanism 50. The circulation mechanism 50 is a mechanism that supplies ink to the liquid ejecting module 40 and recovers ink discharged from the liquid ejecting module 40 such that the ink can be re-supplied to the liquid ejecting module 40. The circulation mechanism 50 has, for example, a sub-tank that stores ink, a supply flow path for supplying ink from the sub-tank to the liquid ejecting module 40, a recovery flow path for recovering ink from the liquid ejecting module to the sub-tank, and a pump for transporting ink. These are provided for each of the aforementioned first ink and second ink. By the operation of the circulation mechanism 50 as described above, it is possible to suppress an increase in the viscosity of the ink and reduce the retention of air bubbles in the ink.

### 1-2. Liquid Ejecting Module

FIG. 2 is a perspective view of the liquid ejecting module 40 having the liquid ejecting head 10 according to the embodiment. As shown in FIG. 2, the liquid ejecting module 40 has a support body 41 and the plurality of liquid ejecting heads 10.

The support body 41 is a member that supports the plurality of liquid ejecting heads 10. In an example shown in FIG. 2, the support body 41 is a plate-shaped member made of metal or the like, and is provided with mounting holes 41a for mounting the plurality of liquid ejecting heads 10. The plurality of liquid ejecting heads 10 are inserted into the mounting holes 41a in a state of being lined up in the X-axis direction, and each liquid ejecting head 10 is fixed to the support body 41 by screwing or the like. In FIG. 2, two liquid ejecting heads 10 are representatively shown. The number of liquid ejecting heads 10 in the liquid ejecting module 40 is optional. Further, the shape of the support body 41 and the like are not limited to the example shown in FIG. 2, and are optional.

### 1-3. Liquid Ejecting Head

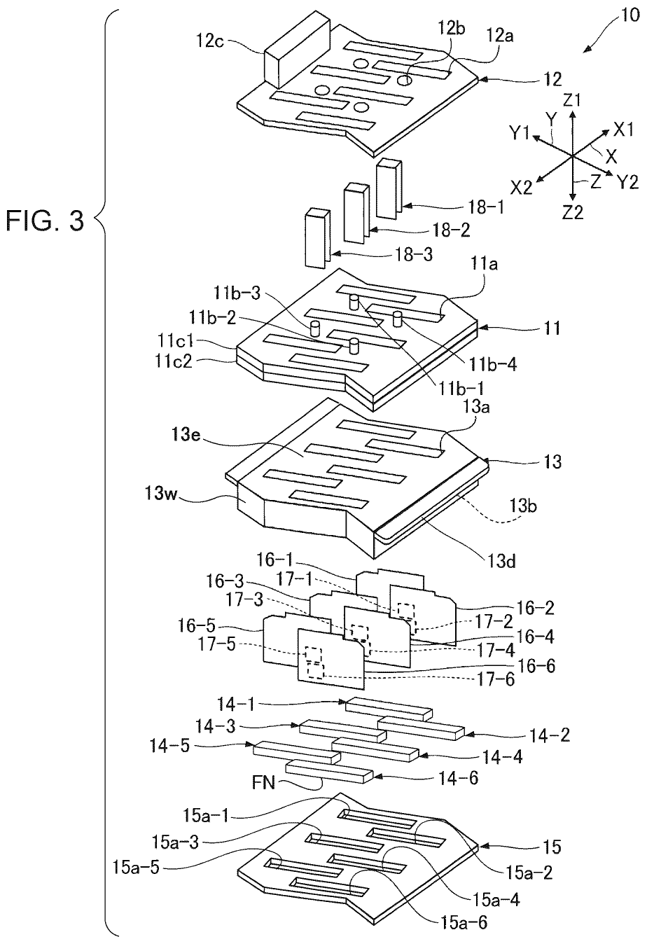

FIG. 3 is an exploded perspective view of the liquid ejecting head 10 shown in FIG. 2. As shown in FIG. 3, the liquid ejecting head 10 has a flow path member 11, a circuit substrate 12, a holder 13, head chips 14-1 to 14-6, a fixing plate 15, wiring substrates 16-1 to 16-6, drive circuits 17-1 to 17-6, and separation members 18-1 to 18-3.

In the following, the head chips 14-1 to 14-6 may be referred to as a head chip 14 without distinction, the wiring substrates 16-1 to 16-6 may be referred to as a wiring substrate 16 without distinction, the drive circuits 17-1 to 17-6 may be referred to as a drive circuit 17 without distinction, and the separation members 18-1 to 18-3 may be referred to as a separation member 18 without distinction.

The circuit substrate 12, the flow path member 11, holder 13, the plurality of head chips 14-1 to 14-6, and the fixing plate 15 are stacked in this order in the Z2 direction and bonded to each other by an adhesive or screws or the like. Here, the wiring substrate 16 is drawn out to each head chip 14, and the wiring substrate 16 is coupled to the circuit substrate 12 through a wiring hole 13a (to be described later) of the holder 13 and a wiring hole 11a (to be described later) of the flow path member 11. The drive circuit 17 is provided on each wiring substrate 16. The separation member 18 is inserted between the flow path member 11 and the circuit substrate 12 into a wiring hole 13a (to be described later) of the holder 13 and a wiring hole 11a (to be described later) of the flow path member 11, and blocks electrical continuity between the drive circuit 17 and the holder 13. Hereinafter, each portion of the liquid ejecting head 10 will be briefly described in order with reference to FIG. 3.

The flow path member 11 is a structure in which a flow path for causing ink to flow between the circulation mechanism 50 and the plurality of head chips 14 is provided. As shown in FIG. 3, the flow path member 11 is provided with a plurality of wiring holes 11a and coupling pipes 11b-1 to 11b-4. In addition, although not shown in FIG. 3, the flow path member 11 is provided with a supply flow path for supplying the first ink to the plurality of head chips 14, a supply flow path for supplying the second ink to the plurality of head chips 14, a discharge flow path for discharging the first ink from the plurality of head chips 14, and a discharge flow path for discharging the second ink from the plurality of head chips 14. In the following description, the coupling pipes 11b-1 to 11b-4 may be referred to as a coupling pipe 11b without distinction.

The flow path member 11 has layers 11c1 and 11c2, which are stacked in this order in the Z2 direction. By appropriately providing grooves or holes or the like in these layers, flow paths such as the supply flow path and the discharge flow path described above are formed. The layers 11cl and 11c2 are made of, for example, a resin material and are formed by injection molding. The layer 11cl and the layer 11c2 are bonded to each other, for example, by an adhesive. The thickness, the number, and other aspects of the layers constituting the flow path member 11 are not limited to the example shown in FIG. 3 and are optional.

Each of the plurality of wiring holes 11a is a hole for passing the wiring substrate 16 therethrough, and penetrates the flow path member 11 in the Z-axis direction. In the example shown in FIG. 3, the wiring hole 11a is provided for each head chip 14, and each wiring hole 11a is used to pass not only the wiring substrate 16 but also the separation member 18 therethrough. Each of the coupling pipes 11b-1 to 11b-4 protrudes in the Z1 direction from the layer 11c1. The coupling pipe 11b-1 is a pipe body that constitutes a flow path for introducing the first ink into the flow path member 11. The coupling pipe 11b-2 is a pipe body that constitutes a flow path for introducing the second ink into the flow path member 11. On the other hand, the coupling pipe 11b-3 is a pipe body that constitutes a flow path for discharging the first ink from the flow path member 11. The coupling pipe 11b-4 is a pipe body that constitutes a flow path for discharging the second ink from the flow path member 11.

The circuit substrate 12 is a mounting component for electrically coupling the control unit 20 and the wiring substrate 16. The circuit substrate 12 is, for example, a rigid wiring substrate. A connector 12c is installed on the surface of the circuit substrate 12 facing the Z1 direction. The connector 12c is a coupling component for electrically coupling to the control unit 20. Furthermore, the circuit substrate 12 is provided with a plurality of wiring holes 12a and a plurality of holes 12b. Each wiring hole 12a is a hole for passing a wiring substrate 16 therethrough. A terminal (not shown) that is coupled to the wiring substrate 16 through the wiring hole 12a is provided on the surface of the circuit substrate 12 facing the Z1 direction. In the example shown in FIG. 3, the wiring hole 12a is provided for each head chip 14. Each hole 12b is a hole for passing the aforementioned coupling pipe 11b therethrough. The coupling pipe 11b through the hole 12b protrudes from the circuit substrate 12 in the Z1 direction.

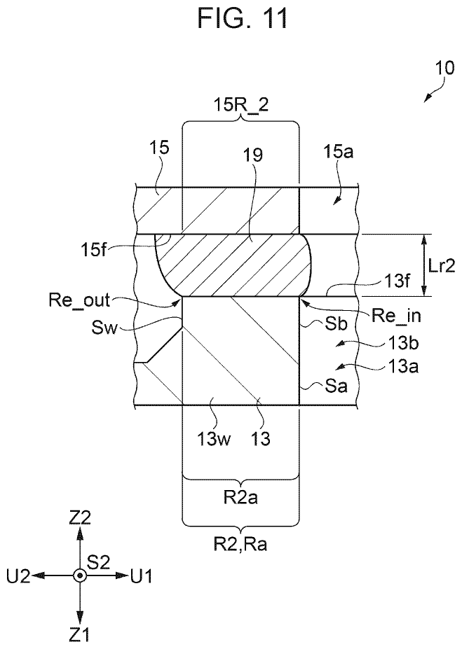

The holder 13 is a structure that accommodates and supports the plurality of head chips 14. The holder 13 is formed of, for example, a resin material, a metal material, or the like. The holder 13 has a plate-like shape that extends in directions perpendicular to the Z-axis. The holder 13 is provided with a plurality of wiring holes 13a, an accommodation portion 13b, an outer peripheral wall 13w, and a bottom portion 13e. The outer peripheral wall 13w is a wall that surrounds the plurality of accommodation portions 13b when viewed along the Z-axis. Each wiring hole 13a is a hole for passing the wiring substrate 16 therethrough, and has a side surface Sa (see FIG. 11). In the example shown in FIG. 3, the wiring hole 13a is provided for each head chip 14, and each wiring hole 13a is used to pass not only the wiring substrate 16 but also the separation member 18 therethrough, and allows coupling between the flow path member 11 and each head chip 14.

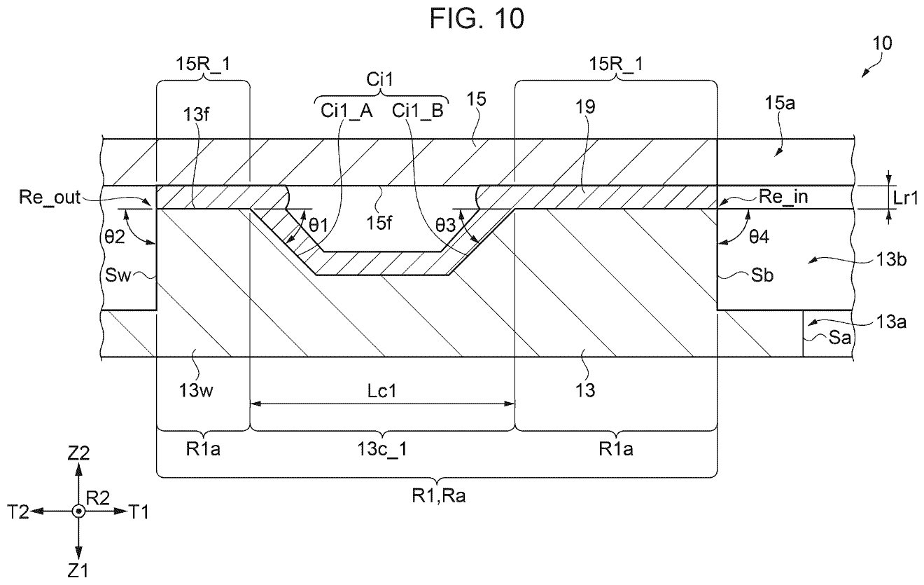

The accommodation portion 13b is a portion recessed in the Z1 direction and provided on the surface of the holder 13 facing the Z2 direction, and accommodates the plurality of head chips 14 therein. The accommodation portion 13b has a side surface Sb (see FIG. 10). In this way, the holder 13 holds the head chips 14-1 to 14-6 between the holder 13 and the fixing plate 15. That is, the outer peripheral wall 13w surrounds the head chip 14 when viewed along the Z-axis. In addition, the outer peripheral wall 13w has a flange portion 13d that is provided for fixing the liquid ejecting head 10 to the support body 41 and that protrudes in the Y1 direction and the Y2 direction. The bottom portion 13e is a portion that defines the bottom surface of the accommodation portion 13b. The bottom portion 13e surrounds the plurality of wiring holes 13a when viewed along the Z-axis.

In the present embodiment, the holder 13 holds six head chips 14-1 to 14-6. These head chips 14 are arranged in the X2 direction in the order of head chips 14-1, 14-2, 14-3, 14-4, 14-5, and 14-6. Here, the head chips 14-1, 14-3, and 14-5 are disposed at positions shifted in the Y1 direction with respect to the head chips 14-2, 14-4, and 14-6. However, the head chips 14-1 to 14-6 have portions that overlap each other as viewed in the X1 direction or the X2 direction. Further, arrangement directions DN (see FIG. 4) of a plurality of nozzles N, which will be described later, of the head chips 14-1 to 14-6 are parallel to each other. Furthermore, each of the head chips 14-1 to 14-6 is disposed such that the arrangement direction DN is inclined with respect to the direction DM which is the transport direction of the medium M.

Each head chip 14 ejects ink. Specifically, although not shown in FIG. 3, each head chip 14 has a plurality of nozzles N for ejection of the first ink and a plurality of nozzles N for ejection of the second ink. The nozzles N are provided at a nozzle surface FN, which is a surface of each head chip 14 that faces the Z2 direction. The configuration of the head chips 14 will be described later.

Note that a plan view seen in a direction perpendicular to the nozzle surface FN is also simply referred to as a “plan view”.

The fixing plate 15 is a plate member for fixation of the plurality of head chips 14 to the holder 13. Specifically, the fixing plate 15 is disposed in a state where the plurality of head chips 14 are interposed between the fixing plate 15 and the holder 13, and is fixed to the holder 13 by means of an adhesive. The fixing plate 15 is made of, for example, a metal material. The material constituting the fixing plate 15 is not limited to metal, but may be, for example, resin or the like.

The fixing plate 15 is provided with exposure opening portions 15a-1 to 15a-6 for exposing a plurality of nozzles N (to be described later) of the head chips 14-1 to 14-6. The exposure opening portions 15a-1 to 15a-6 correspond one-to-one to the head chips 14-1 to 14-6. Thus, the fixing plate 15 has the exposure opening portions 15a-1 to 15a-6 for exposing a plurality of nozzles N (to be described later) of the head chips 14-1 to 14-6, and the head chips 14-1 to 14-6 are fixed to the fixing plate 15. Hereinafter, the exposure opening portions 15a-1 to 15a-6 may be referred to as an exposure opening portion 15a without distinction.

The wiring substrate 16 is a flexible substrate including a wiring electrically coupled to piezoelectric elements 14f (to be described later), and is, for example, flexible printed circuits (FPCs) or a chip on film (COF). The drive circuit 17 is provided on one surface of the wiring substrate 16. In this manner, the wiring substrate 16 has the drive circuit 17 and is electrically coupled to the head chip 14. That is, the wiring substrate 16-1 has the drive circuit 17-1 and is electrically coupled to the head chip 14-1. The wiring substrate 16-2 has the drive circuit 17-2 and is electrically coupled to the head chip 14-2. Similarly, the wiring substrates 16-3 to 16-6 have the drive circuits 17-3 to 17-6, and are electrically coupled to the head chips 14-3 to 14-6.

The drive circuit 17 includes a plurality of switching elements corresponding to each of a plurality of piezoelectric elements 14f corresponding to a plurality of nozzles N (to be described later), and is a circuit that selects whether or not to supply the drive signal Com to each piezoelectric element 14f.

The separation member 18 is a member that is disposed between the drive circuit 17 and the holder 13 to block electrical continuity between the drive circuit 17 and the holder 13. In the example shown in FIG. 3, the separation member 18 is a structure in which a sheet-like or film-like member is folded.

### 1-4. Head Chip

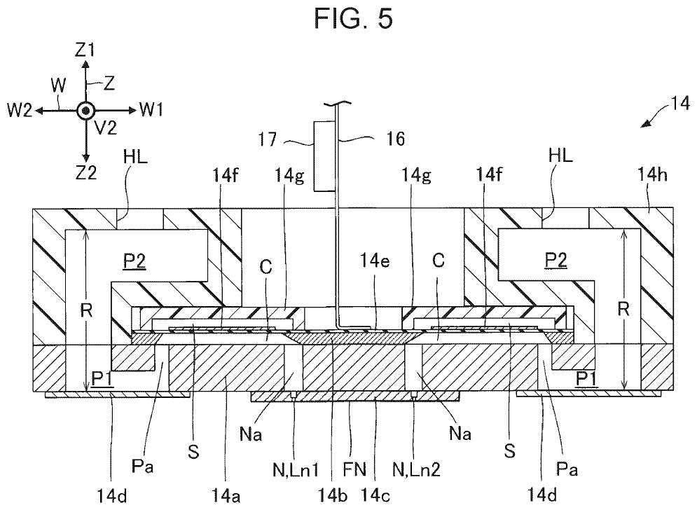

FIG. 4 is an exploded perspective view of the head chip 14 of the liquid ejecting head 10. FIG. 5 is a cross-sectional view taken along line V-V in FIG. 4. In the following, for convenience of description, a V-axis and a W-axis that intersect the Z-axis and intersect each other will be used appropriately. One direction along the V-axis is referred to as a V1 direction, and a direction opposite to the V1 direction is referred to as a V2 direction. Similarly, directions opposite to each other along the W-axis are referred to as a W1 direction and a W2 direction. When the V1 direction and the V2 direction are not limited, a direction along the V-axis is referred to as a V-axis direction. Similarly, the W1 direction and the W2 direction are not limited, a direction along the W-axis is referred to as a W-axis direction. Here, the V-axis is an axis parallel to an arrangement direction DN in which a nozzle row Ln1 and a nozzle row Ln2 (to be described later) extend, and extends in a direction inclined with respect to the Y-axis. The W-axis extends in a direction inclined with respect to the X-axis. Note that the V-axis and the W-axis are typically orthogonal to each other, but are not limited thereto. For example, they may intersect at an angle within the range of 80° or more and 100° or less.

As shown in FIGS. 4 and 5, the head chip 14 has a plurality of nozzles N arranged in the V-axis direction.

The plurality of nozzles N of the head chip 14 are divided into the nozzle row Ln1 and the nozzle row Ln2 arranged at intervals in the W-axis direction. Each of the nozzle row Ln1 and the nozzle row Ln2 is a set of a plurality of nozzles N linearly arranged in the V-axis direction.

The head chips 14 have a configuration substantially symmetrical with each other in the W-axis direction. However, positions of the plurality of nozzles N in the nozzle row Ln1 and the plurality of nozzles N in the nozzle row Ln2 in the V-axis direction may coincide with or differ from each other. FIGS. 4 and 5 illustrate a configuration in which positions of the plurality of nozzles N in the nozzle row Ln1 and the plurality of nozzles N in the nozzle row Ln2 in the V-axis direction coincide with each other.

As shown in FIGS. 4 and 5, the head chip 14 has a flow path substrate 14a, a pressure chamber substrate 14b, a nozzle plate 14c, a vibration absorbing body 14d, a vibration plate 14e, a plurality of piezoelectric elements 14f, a cover 14g, and a case 14h.

The flow path substrate 14a and the pressure chamber substrate 14b are stacked in this order in the Z1 direction, and form a flow path for supplying the ink to the plurality of nozzles N. The vibration plate 14e, the plurality of piezoelectric elements 14f, the cover 14g, and the case 14h are installed in a region located in the Z1 direction with respect to a stacked body formed by the flow path substrate 14a and the pressure chamber substrate 14b. On the other hand, the nozzle plate 14c and the vibration absorbing body 14d are installed in a region located in the Z2 direction with respect to the stacked body. Each element of the head chip 14 is schematically a plate-shaped member elongated in the V-axis direction, and is bonded to each other with, for example, an adhesive. Hereinafter, each element of the head chip 14 will be described in order.

The nozzle plate 14c is a plate-shaped member provided with the plurality of nozzles N of each of the nozzle row Ln1 and the nozzle row Ln2. Each of the plurality of nozzles N is a through hole through which the ink passes. Here, a surface of the nozzle plate 14c facing the Z2 direction is a nozzle surface FN. The nozzle plate 14c is manufactured in such a manner that a silicon single crystal substrate is processed by a semiconductor manufacturing technique using a processing technique such as dry etching or wet etching, for example. However, other known methods and materials may be appropriately used for manufacturing the nozzle plate 14c. Further, the shape of the nozzle N is not limited to the example shown in the drawing, and may be any shape.

The flow path substrate 14a is provided with a first flow path P1, a plurality of supply flow paths Pa, and a plurality of communication flow paths Na for each of the nozzle row Ln1 and the nozzle row Ln2. The first flow path P1 is a flow path that communicates with the nozzle N and is located upstream of the nozzle N, and is configured as an elongated hole that extends in the V-axis direction in a plan view seen in the Z-axis direction. Each of the supply flow path Pa and the communication flow path Na is a through hole formed for each nozzle N. Each supply flow path Pa communicates with the first flow path P1.

The pressure chamber substrate 14b is a plate-shaped member in which a plurality of pressure chambers C are provided for each of the nozzle row Ln1 and the nozzle row Ln2. The plurality of pressure chambers C are arranged in the V-axis direction. Each pressure chamber C is formed for each nozzle N, and is an elongated space that extends in the W-axis direction in a plan view.

As in the aforementioned nozzle plate 14c, each of the flow path substrate 14a and the pressure chamber substrate 14b is manufactured in such a manner that a silicon single crystal substrate is processed by a semiconductor manufacturing technique, for example. However, other known methods and materials may be appropriately used to manufacture each of the flow path substrate 14a and the pressure chamber substrate 14b.

The pressure chamber C is located between the flow path substrate 14a and the vibration plate 14e. For each of the nozzle row Ln1 and the nozzle row Ln2, a plurality of pressure chambers C are arranged in the V-axis direction. Further, the pressure chamber C communicates with each of the communication flow path Na and the supply flow path Pa. Therefore, the pressure chamber C communicates with the nozzle N through the communication flow path Na and communicates with the first flow path P1 through the supply flow path Pa.

The vibration plate 14e is disposed on the surface of the pressure chamber substrate 14b facing the Z1 direction. The vibration plate 14e is a plate-shaped member that can elastically vibrate. Although not shown, the vibration plate 14e has, for example, an elastic film and an insulating film, which are stacked in this order in the Z1 direction. The elastic film is made of, for example, silicon oxide (SiO₂), and is formed by thermally oxidizing one surface of a silicon single crystal substrate. The insulating film is made of, for example, zirconium oxide (ZrO₂), and is formed by forming a zirconium layer by sputtering and thermally oxidizing the layer.

The vibration plate 14e is not limited to the aforementioned configuration in which the elastic film and the insulating film are stacked, and may be, for example, configured of a single layer or three or more layers. In addition, the material of each layer constituting the vibration plate 14e is not limited to the aforementioned material, and may be, for example, silicon or silicon nitride.

On the surface of the vibration plate 14e facing the Z1 direction, a plurality of piezoelectric elements 14f corresponding to the nozzles N of each of the nozzle row Ln1 and the nozzle row Ln2 are disposed as drive elements, and one end of the wiring substrate 16 is coupled. Each piezoelectric element 14f is a passive element that is deformed by the supply of a potential corresponding to the drive signal Com through the wiring substrate 16, and generates a pressure fluctuation in the ink within the pressure chamber C. Each piezoelectric element 14f has an elongated shape that extends in the W-axis direction in a plan view. The plurality of piezoelectric elements 14f are arranged in the V-axis direction to correspond to the plurality of pressure chambers C. The piezoelectric element 14f overlaps the pressure chamber C in a plan view.

Although not shown, each piezoelectric element 14f has a first electrode, a piezoelectric body, and a second electrode, and these are stacked in the Z1 direction in this order. The first electrodes are individual electrodes disposed to be separated from each other for each piezoelectric element 14f. A potential corresponding to the drive signal Com is supplied to the first electrode. The second electrode is a band-shaped common electrode that extends in the V-axis direction to be continuous across the plurality of piezoelectric elements 14f. For example, a constant potential is supplied to the second electrode. Examples of a metal material of the electrodes include metal materials such as platinum (Pt), aluminum (Al), nickel (Ni), gold (Au), and copper (Cu), and among the materials, one type may be used alone or two or more types may be used in combination in an aspect of alloy or stacking. The piezoelectric body is made of a piezoelectric material such as lead zirconate titanate (Pb(Zr,Ti)O₃). In the piezoelectric element 14f described above, when a voltage is applied between the first electrode and the second electrode, the piezoelectric body is deformed due to an inverse piezoelectric effect. When the vibration plate 14e vibrates in conjunction with this deformation, the pressure in the pressure chamber C fluctuates, which causes the ink to be ejected from the nozzle N. In addition, instead of the piezoelectric element 14f, a heating element that ejects ink from the nozzle N by bubbles generated by heating the ink in the pressure chamber C may be used as the drive element.

The cover 14g is a plate-shaped member installed on the surface of the vibration plate 14e facing the Z1 direction, and protects the plurality of piezoelectric elements 14f and reinforces the mechanical strength of the vibration plate 14e. Here, the plurality of piezoelectric elements 14f are accommodated in a space S between the cover 14g and the vibration plate 14e.

For example, the cover 14g is formed of a resin material.

The case 14h is a case for storing ink supplied to the plurality of pressure chambers C.

The case 14h is made of, for example, a resin material. The case 14h is provided with a second flow path P2 for each of the nozzle row Ln1 and the nozzle row Ln2. The second flow path P2 is a space coupled to the aforementioned first flow path P1, and is configured as an elongated hole that extends in the V-axis direction in a plan view seen in the Z-axis direction. The second flow path P2 communicates with the nozzle N and functions as a reservoir R that stores ink supplied to a plurality of pressure chambers C together with the first flow path P1. The case 14h is provided with two openings HL for each reservoir R. Of the two openings HL, one opening HL is an introduction port for supplying ink to the reservoir R, and the other opening HL is a discharge port for discharging ink from the reservoir R. The ink in each reservoir R is supplied to the pressure chamber C through each supply flow path Pa. The positions, the number, and other aspects of the openings HL for each reservoir R are not limited to the examples shown in FIGS. 4 and 5, and are optional.

The vibration absorbing body 14d, also referred to as a compliance substrate, is a flexible resin film constituting a wall surface of the reservoir R, and absorbs pressure fluctuations of ink in the reservoir R. The vibration absorbing body 14d may be a flexible thin plate made of metal. The surface of the vibration absorbing body 14d facing the Z1 direction is bonded to the flow path substrate 14a with an adhesive or the like.

### 1-5. Regarding Adhesive Portion Between Holder and Fixing Plate

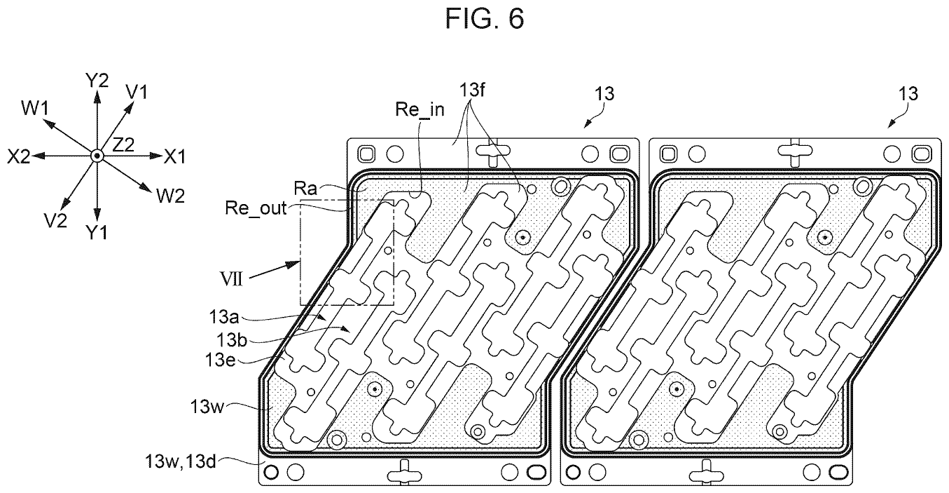

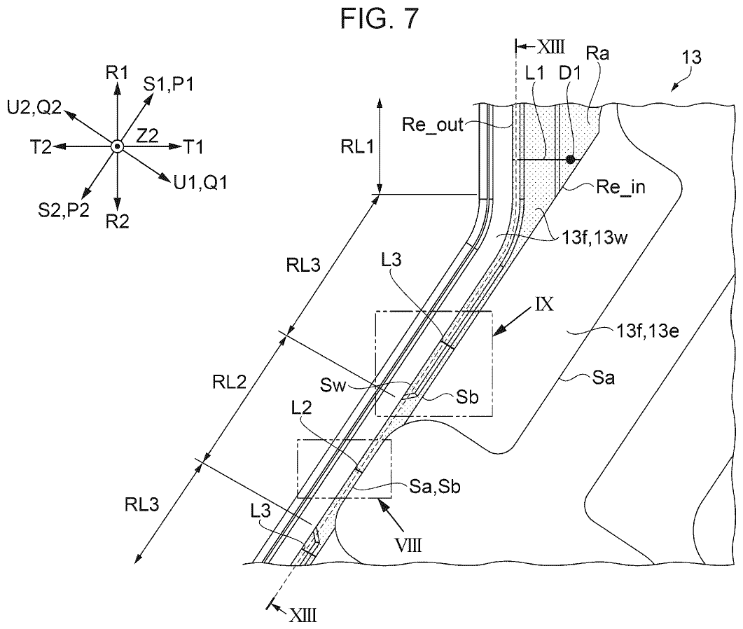

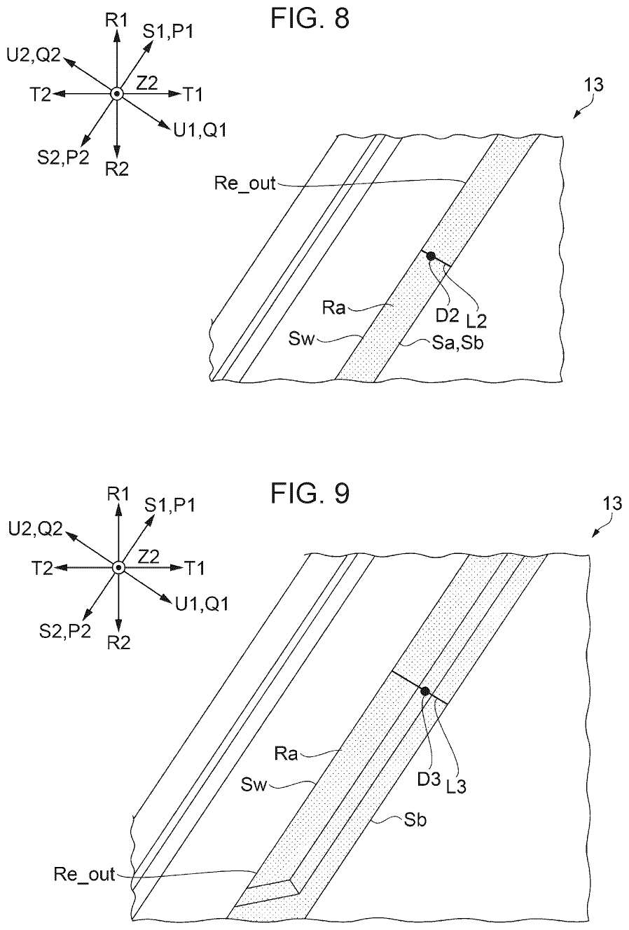

FIG. 6 is a plan view of only the holder 13 of the two liquid ejecting heads 10 shown in FIG. 2, as viewed in the Z1 direction. FIG. 7 is an enlarged view of an area within a frame line VII in FIG. 6. FIGS. 8 and 9 are enlarged views of areas within a frame line VIII and a frame line IX in FIG. 7, respectively.

As shown in FIG. 6, the outer peripheral walls 13w of the holders 13 of the liquid ejecting heads 10 adjacent to each other in the X-axis direction have portions that overlap in the Y-axis direction.

The outer peripheral wall 13w has an end portion in the X-axis direction and an end portion in the Y-axis direction. The end portion in the X-axis direction has a portion along the Y-axis direction and a portion along the V-axis direction. Furthermore, the end portion in the X-axis direction faces the end portion in the X-axis direction of the outer peripheral wall 13w of the holder 13 of the liquid ejecting head 10 adjacent to each other in the X-axis direction. In the present embodiment, the end portion in the X-axis direction has a portion along the Y-axis direction and a portion along the V-axis direction, but the end portion in the X-axis direction may also have a portion along the Y-axis direction and a portion along the X-axis direction.

The end portion in the Y-axis direction is along the X-axis direction.

As shown in FIG. 7 and other drawing, the outer peripheral wall 13w of the holder 13 has a first surface 13f that is a surface facing in the Z2 direction. As shown in FIG. 10 and other drawings, the fixing plate 15 has a second surface 15f, that is, a surface facing the holder 13, that is, a surface facing the Z1 direction. The holder 13 and the fixing plate 15 are adhered together by adhering the first surface 13f and the second surface 15f with an adhesive 19.

It is desirable that the adhesive 19 is of one type. Moreover, it is desirable that the adhesive 19 that adheres the holder 13 to the fixing plate 15 is not applied at different timings. In other words, it is desirable to apply the remaining adhesive 19 before a portion of the adhesive 19 is applied and cured.

The first surface 13f includes irregularities and also includes portions that are not flat. The regions indicated by dot patterns in FIGS. 6, 7, 8, and 9 are adhesive regions Ra of the first surface 13f where the adhesive 19 is applied. In other words, the first surface 13f has an adhesive region Ra which is a region in contact with the adhesive 19. The adhesive region Ra is a region to which the adhesive 19 is applied, and may include a region which is not adhered to the fixing plate 15. In other words, a portion of the adhesive 19 in contact with the adhesive region Ra may not be in contact with the fixing plate 15.

As shown in FIG. 7, when viewed in the Z1 direction, a line segment that passes through any first point D1 in the adhesive region Ra and connects the end portions of the adhesive region Ra at the shortest distance is defined as a first line segment L1. Similarly, as shown in FIGS. 7 and 8, when viewed in the Z1 direction, a line segment that passes through any second point D2 in the adhesive region Ra and connects the end portions of the adhesive region Ra at the shortest distance is defined as a second line segment L2.

The second point D2 is a point different from the first point D1. Similarly, as shown in FIGS. 7 and 9, when viewed in the Z1 direction, a line segment that passes through any third point D3 in the adhesive region Ra and connects the end portions of the adhesive region Ra at the shortest distance is defined as a third line segment L3. The third point D3 is a point different from the first point D1 and the second point D2.

Here, at least one of the end portions of the adhesive region Ra is an outer edge Re_out of the adhesive region Ra. The outer edge Re_out is the outermost portion of the edge of the adhesive region Ra.

The first point D1, the second point D2, and the third point D3 are not located at the end portions of the adhesive region Ra. Therefore, the entire areas of the first line segment L1, the second line segment L2, and the third line segment L3 are not located at the end portion of the adhesive region Ra.

The first line segment L1 is longer than the second line segment L2 and is longer than the third line segment L3. The third line segment L3 is longer than the second line segment L2.

Here, a spatial axis along the first line segment L1 is a T-axis, a spatial axis along the second line segment L2 is a U-axis, and a spatial axis along the third line segment L3 is a Q-axis. Furthermore, a spatial axis perpendicular to the T-axis and the Z-axis is an R-axis, a spatial axis perpendicular to the U-axis and the Z-axis is an S-axis, and a spatial axis perpendicular to the Q-axis and the Z-axis is a P-axis. Directions opposite to each other along the T-axis are referred to as a T1 direction and a T2 direction; similarly, directions opposite to each other along the U-axis are referred to as a U1 direction and a U2 direction, and directions opposite to each other along the Q-axis are referred to as a Q1 direction and a Q2 direction. Similarly, directions opposite to each other along the R-axis are referred to as an R1 direction and an R2 direction, directions opposite to each other along the S-axis are referred to as an S1 direction and an S2 direction, and directions opposite to each other along the P-axis are referred to as a P1 direction and a P2 direction.

Furthermore, when the T1 direction and the T2 direction are not limited, a direction along the T-axis is referred to as a T-axis direction. The T-axis direction is a direction along the first line segment L1. Similarly, when the U1 direction and the U2 direction are not limited, a direction along the U-axis is referred to as a U-axis direction, and when the Q1 direction and the Q2 direction are not limited, a direction along the Q-axis is referred to as a Q-axis direction. The U-axis direction is a direction along the second line segment L2, and the Q-axis direction is a direction along the third line segment L3. Similarly, when the R1 direction and the R2 direction are not limited, the direction along the R-axis is referred to as an R-axis direction, when the S1 direction and the S2 direction are not limited, the direction along the S-axis is referred to as an S-axis direction, and when the P1 direction and the P2 direction are not limited, the direction along the P-axis is referred to as a P-axis direction.

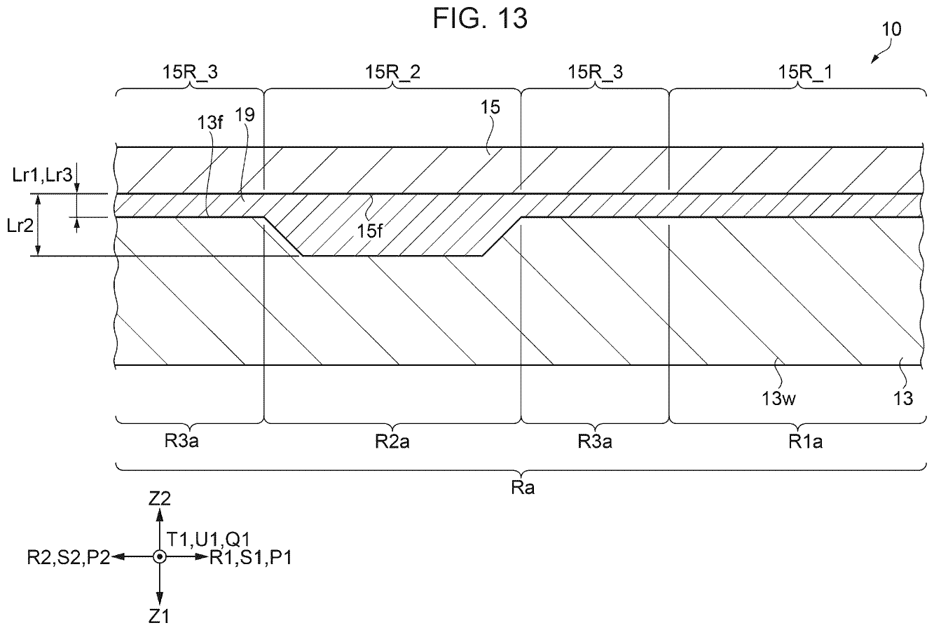

In FIG. 10 and subsequent drawings, when the vertical direction of the drawing is the Z-axis direction, the Z1 direction is shown as the downward direction of the drawing. FIGS. 10, 11, and 12 are cross-sectional views taken along the first line segment L1, the second line segment L2, and the third line segment L3 in FIG. 7, respectively, as viewed in the R1 direction, the S1 direction, and the P1 direction, respectively. FIG. 13 is a cross-sectional view taken along line XIII-XIII in FIG. 7, as viewed in the T2 direction, the U2 direction or the Q2 direction. FIGS. 10, 11, 12, and 13 show a fixing plate 15 in addition to the holder 13.

As shown in FIGS. 10, 11, 12, and 13, the holder 13 is stacked in the Z1 direction on the fixing plate 15. The first surface 13f has a region R1 that overlaps the first line segment L1 in the Z1 direction, a region R2 that overlaps the second line segment L2 in the Z1 direction, and a region R3 that overlaps the third line segment L3 in the Z1 direction. These regions are lines and have no width in the R-axis direction, no width in the S-axis direction, and no width in the P-axis direction.

As shown in FIG. 10, a region R1 of the first surface 13f that overlaps the first line segment L1 in the Z1 direction has two first adhesive regions R1a that are portions of the adhesive region Ra, and a first recess 13c_1 that is recessed in the Z1 direction further than the first adhesive regions R1a. The first adhesive regions R1a are regions that are adhered to the fixing plate 15. That is, the adhesive 19 disposed in the first adhesive regions R1a is in contact with the fixing plate 15. In other words, the adhesive 19 is disposed between the first adhesive regions R1a and the fixing plate 15, and is filled with the adhesive 19. The first adhesive region R1a are regions in the region R1 that overlaps the first line segment L1 in the Z1 direction and in which a distance Lr1 in the Z-axis direction from the fixing plate 15 is the smallest.

The first recess 13c_1 is a configuration for causing excess adhesive 19 to flow out of the adhesive 19 applied to the first adhesive regions R1a. At least a portion of the first recess 13c_1 is not adhered to the fixing plate 15. In other words, at least a portion of the adhesive 19 disposed in the first recess 13c_1 is not in contact with the fixing plate 15. In other words, a space where the adhesive 19 is not disposed, that is, a space that is not filled with the adhesive 19, is formed between the first recess 13c_1 and the fixing plate 15.

A portion of the first recess 13c_1 may be adhered to the fixing plate 15. In other words, the adhesive 19 in contact with the first recess 13c_1 may also be in contact with the fixing plate 15.

The first recess 13c_1 is located in the T-axis direction with respect to the first adhesive regions R1a. The first adhesive regions R1a are disposed at the end portions of the first recess 13c_1 in the T1 direction and the T2 direction. In other words, the first adhesive regions R1a are disposed on both ends of the first recess 13c_1 in the T-axis direction.

As shown in FIG. 11, a region R2 of the first surface 13f that overlaps the second line segment L2 in the Z1 direction is a second adhesive region R2a. The second adhesive region R2a is a region that is adhered to the fixing plate 15. That is, the adhesive 19 disposed in the second adhesive region R2a is in contact with the fixing plate 15. In other words, the adhesive 19 is disposed between the second adhesive region R2a and the fixing plate 15, and is filled with the adhesive 19.

A distance Lr2 in the Z-axis direction between the second adhesive region R2a and the fixing plate 15 is greater than the distance Lr1 in the Z-axis direction between the first adhesive region R1a and the fixing plate 15. That is, the thickness in the Z-axis direction of the adhesive 19 stacked in the second adhesive region R2a is greater than the thickness in the Z-axis direction of the adhesive 19 stacked in the first adhesive regions R1a. Further, the distance Lr2 in the Z-axis direction between the second adhesive region R2a and the fixing plate 15 is greater than a distance Lr3 in the Z-axis direction between a third adhesive region R3a (to be described later) and the fixing plate 15. That is, the thickness in the Z-axis direction of the adhesive 19 stacked in the second adhesive region R2a is greater than the thickness in the Z-axis direction of the adhesive 19 stacked in the third adhesive region R3a. In the present embodiment, the distance Lr1 and the distance Lr3 are the same. However, the distances may be different.

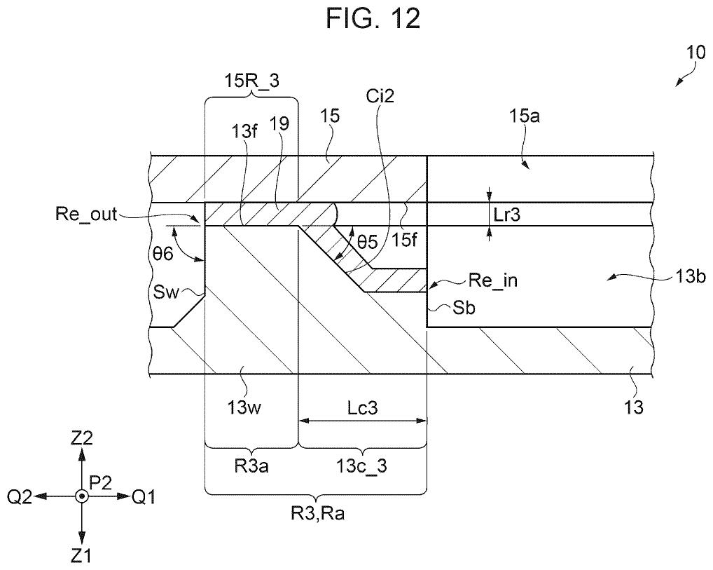

As shown in FIG. 12, a region R3 of the first surface 13f that overlaps the third line segment L3 in the Z1 direction has a third adhesive region R3a and a third recess 13c_3 that is recessed in the Z1 direction further than the third adhesive region R3a. The third adhesive region R3a is a region that is adhered to the fixing plate 15. That is, the adhesive 19 disposed in the third adhesive region R3a is in contact with the fixing plate 15. In other words, the adhesive 19 is disposed between the third adhesive region R3a and the fixing plate 15, and is filled with the adhesive 19. The third adhesive region R3a is a region in the region R3 that overlaps the third line segment L3 in the Z1 direction and in which the distance Lr3 in the Z-axis direction from the fixing plate 15 is the smallest.

The third recess 13c_3 is a member for causing excess adhesive to flow out of the adhesive 19 applied to the third adhesive region R3a. At least a portion of the third recess 13c_3 is not adhered to the fixing plate 15. In other words, at least a portion of the adhesive 19 disposed in the third recess 13c_3 is not in contact with the fixing plate 15. In other words, a space where the adhesive 19 is not disposed, that is, a space that is not filled with the adhesive 19, is formed between the third recess 13c_3 and the fixing plate 15. On the other hand, a portion of the third recess 13c_3 may be adhered to the fixing plate 15. In other words, the adhesive 19 in contact with the third recess 13c_3 may also be in contact with the fixing plate 15.

The third recess 13c_3 is located in the Q1 direction with respect to the third adhesive region R3a. However, the third recess 13c_3 may be configured to be located in the Q2 direction with respect to the third adhesive region R3a. In other words, the third recess 13c_3 is located in either the Q1 direction or the Q2 direction with respect to the third adhesive region R3a. That is, the third adhesive region R3a is disposed in the Q1 direction of the third recess 13c_3 and is not disposed in the Q2 direction of the third recess 13c_3, or the third adhesive region R3a is disposed in the Q2 direction of the third recess 13c_3 and is not disposed in the Q1 direction of the third recess 13c_3.

With the liquid ejecting head 10 according to the present embodiment, the first recess 13c_1 is provided in a region R1 of the first surface 13f that overlaps the first line segment L1 in the Z1 direction. This causes excess adhesive 19 to flow into the first recess 13c_1, making it possible to suppress the adhesive 19 from overflowing to other locations. Similarly, the third recess 13c_3 is provided in a region R3 of the first surface 13f that overlaps the third line segment L3 in the Z1 direction. This causes excess adhesive 19 to flow into the third recess 13c_3, making it possible to suppress the adhesive 19 from overflowing to other locations.

In the region R2 of the first surface 13f that overlaps the second line segment L2, which is shorter than the first line segment L1 and the third line segment L3, in the Z1 direction, the adhesive 19 can be suppressed from overflowing by increasing the distance Lr2 in the Z-axis direction between the fixing plate 15 and the holder 13.

In other words, in the narrow region, the distance in the Z-axis direction between the holder 13 and the fixing plate 15 is made large, and in the wide region, a recess is provided without making the distance in the Z-axis direction between the holder 13 and the fixing plate 15 large. Therefore, even when a portion of the adhesive region Ra includes a narrow portion, it is possible to suppress the adhesive 19 from overflowing while minimizing the decrease in strength.

As described above, since the third line segment L3 is shorter than the first line segment L1, the region R3 that overlaps the third line segment L3 in the Z1 direction is shorter than the region R1 that overlaps the first line segment L1 in the Z1 direction. The region R1 that overlaps the first line segment L1 in the Z1 direction has two first adhesive regions R1a and a first recess 13c_1, while the region R3 that overlaps the third line segment L3 in the Z1 direction has one third adhesive region R3a and a third recess 13c_3.

This is because the length of the region R3 that overlaps the third line segment L3 in the Z1 direction is so small in the Q-axis direction that it is not possible to provide the third adhesive regions R3a at both ends of the third recess 13c_3 in the Q-axis direction. Therefore, the length of the third adhesive region R3a in the Q-axis direction is smaller than the sum of the lengths of the first adhesive regions R1a in the T-axis direction. Further, a length Lc3 of the third recess 13c_3 in the Q-axis direction is equal to or less than a length Lc1 of the first recess 13c_1 in the T-axis direction.

As described above, since the second line segment L2 is shorter than the first line segment L1, the region R2 that overlaps the second line segment L2 in the Z1 direction is shorter than the region R1 that overlaps the first line segment L1 in the Z1 direction. The region R1 that overlaps the first line segment L1 in the Z1 direction has two first adhesive regions R1a and a first recess 13c_1, while the region R2 that overlaps the second line segment L2 in the Z1 direction has one second adhesive region R2a. In the present embodiment, the length of the second adhesive region R2a in the U-axis direction, that is, the length of the second line segment L2, is shorter than the length Lc1 of the first recess 13c_1 in the T-axis direction.

This is because the length of the region R2 that overlaps the second line segment L2 in the Z1 direction is so small in the U-axis direction that the first recess 13c_1 and the first adhesive region R1a cannot be provided therein.

Specifically, the length Lc1 of the first recess 13c_1 in the T-axis direction is 1 mm or more, and the length of the second adhesive region R2a in the U-axis direction, that is, the length of the second line segment L2, is less than 0.5 mm.

The second adhesive region R2a is linear when viewed in the S-axis direction, which is a direction orthogonal to the Z1 direction and the second line segment L2. That is, the second adhesive region R2a is not a folded line and does not include irregularities.

This is because the length of the second adhesive region R2a in the U-axis direction is so small that it is not possible to provide a protrusion or a recess.

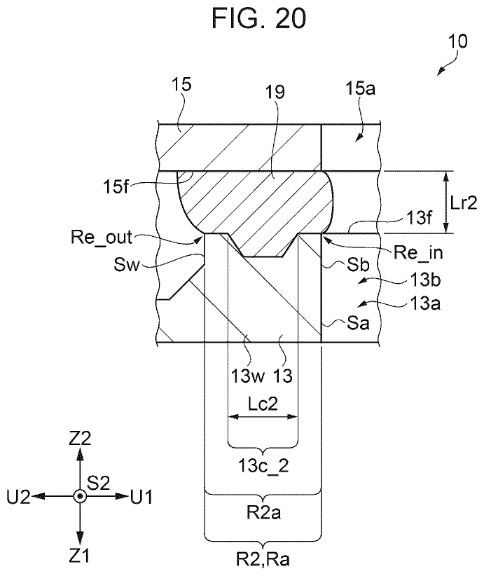

The second adhesive region R2a being linear means that the second adhesive region R2a is not limited to being linear when viewed in the S-axis direction, but also includes cases where the second adhesive region R2a has fine irregularities that arise during the manufacturing process. The fine irregularities are irregularities in which the distance in the Z-axis direction between the point located most in the Z2 direction and the point located most in the Z1 direction is 30 μm or less. However, as shown in a fourth modification example (see FIG. 20) described later, the second adhesive region R2a may have a second recess 13c_2.

As shown in FIGS. 6 and 7, the second adhesive region R2a is disposed at the end portion of the outer peripheral wall 13w in the X-axis direction. This is because, for example, the end portion of the outer peripheral wall 13w in the X-axis direction needs to have a small width in order to arrange the nozzles at a high density. Further, the second adhesive region R2a is not disposed at the end portion of the outer peripheral wall 13w in the Y-axis direction. Furthermore, the second adhesive region R2a is provided in the portion of the outer peripheral wall 13w where the thickness is smallest.

Hereinafter, the first line segment L1 refers not only to the first line segment L1 shown in FIG. 7, but also to a line segment that overlaps the region R1 including the plurality of first adhesive regions R1a and the first recesses 13c_1 disposed therebetween. In addition, the second line segment L2 refers not only to the second line segment L2 shown in FIGS. 7 and 8, but also to a line segment that overlaps the region R2 including the second adhesive region R2a that is separated from the fixing plate 15 by the distance Lr2 in the Z-axis direction. The third line segment L3 refers not only to the third line segment L3 shown in FIGS. 7 and 9, but also to a line segment that overlaps the region R3 including the third adhesive region R3a and the third recess 13c_3.

As shown in FIG. 7, the first surface 13f has a region RL1 in which the first line segment L1 can be drawn, a region RL2 in which the second line segment L2 can be drawn, and regions RL3 in which the third line segments L3 can be drawn.

In the present embodiment, the regions RL3 in which the third line segments L3 can be drawn are disposed on both ends in the S-axis direction of the region RL2 in which the second line segment L2 can be drawn. In the present embodiment, the region RL3 in which the third line segment L3 can be drawn is disposed adjacent to the region RL1 in which the first line segment L1 can be drawn. That is, in the present embodiment, the region RL2 in which the second line segment L2 can be drawn is not adjacent to the region RL1 in which the first line segment L1 can be drawn.

This is because a distance from a side surface Sw of the outer peripheral wall 13w to a side surface Sb of the accommodation portion 13b or a side surface Sa of the wiring hole 13a does not change suddenly but changes gradually along the outer edge Re_out. However, the region RL2 in which the second line segment L2 can be drawn may be adjacent to the region RL1 in which the first line segment L1 can be drawn.

As shown in FIG. 10, it is preferable that at least one of the T1 direction and the T2 direction of the first recess 13c_1 is inclined. That is, the first recess 13c_1 preferably has at least one of a first inclined portion Ci1_A and a first inclined portion Ci1_B, which will be described later.

The first inclined portion Ci1_A is an inclined portion that is adjacent in the T1 direction to the first adhesive region R1a disposed closer to the T2 direction out of the two first adhesive regions R1a, and that extends along a direction that is a combination of the T1 direction and the Z1 direction.

The first inclined portion Ci1_B is an inclined portion that is adjacent in the T2 direction to the first adhesive region R1a disposed closer to the T1 direction out of the two first adhesive regions R1a, and that extends along a direction that is a combination of the T2 direction and the Z1 direction. Hereinafter, when the first inclined portion Ci1_A and the first inclined portion Ci1_B are not limited, they will be described as a first inclined portion Ci1.

As shown in FIG. 12, it is preferable that the end portion of the third recess 13c_3 in the Q2 direction is also inclined. That is, it is preferable that the third recess 13c_3 also has a second inclined portion Ci2 that is adjacent to the third adhesive region R3a in the Q1 direction and that extends along a direction that is a combination of the Q1 direction and the Z1 direction.

Further, the third recess 13c_3 may be configured to be disposed in the Q2 direction of the third adhesive region R3a. In this case, it is preferable that the third recess 13c_3 has a second inclined portion Ci2 that is adjacent to the third adhesive region R3a in the Q2 direction and that extends along a direction that is a combination of the Q2 direction and the Z1 direction. That is, it is preferable that the end portion of the third recess 13c_3 in the Q2 direction is inclined.

Incidentally, the side surface Sw of the outer peripheral wall 13w shown in FIGS. 10 and 12 is an outer peripheral surface adjacent to the first adhesive region R1a or the third adhesive region R3a, and is a surface to which the adhesive 19 is not applied. In the example shown in FIG. 10, the side surface Sw is disposed adjacent in the T2 direction to the first adhesive region R1a disposed closer in the T2 direction out of the two first adhesive regions R1a. The first recess 13c_1 is disposed adjacent to the first adhesive region R1a in the T1 direction, the first adhesive region R1a being disposed closer to the T2 direction.

In addition, the side surface Sb of the accommodation portion 13b is disposed adjacent in the T1 direction to the first adhesive region R1a disposed closer in the T1 direction out of the two first adhesive regions R1a. The first recess 13c_1 is disposed adjacent to the first adhesive region R1a in the T2 direction, the first adhesive region R1a being disposed closer to the T1 direction.

In addition, as shown in FIG. 12, the side surface Sw of the outer peripheral wall 13w is disposed adjacent to the third adhesive region R3a in the Q2 direction, and the third recess 13c_3 is disposed in the Q1 direction of the third adhesive region R3a.

As shown in FIG. 10, an acute angle θ1 that the first inclined portion Ci1_A makes with the T-axis is smaller than an angle θ2 that the side surface Sw of the outer peripheral wall 13w makes with an imaginary line drawn in the T2 direction from the end portion in the T2 direction of the adhesive region Ra. An acute angle θ3 that the first inclined portion Ci1_B makes with the T-axis is smaller than an angle θ4 that the side surface Sb of the accommodation portion 13b makes with an imaginary line drawn in the T1 direction from the end portion in the T1 direction of the adhesive region Ra.

Typically, the angle θ2 that the side surface Sw of the outer peripheral wall 13w makes with an imaginary line drawn in the T2 direction from the end portion in the T2 direction of the adhesive region Ra, and the angle θ4 that the side surface Sb of the accommodation portion 13b makes with an imaginary line drawn in the T1 direction from the end portion in the T1 direction of the adhesive region Ra, are both 90°.

As shown in FIG. 12, an acute angle θ5 that the second inclined portion Ci2 makes with the Q-axis is smaller than an angle θ6 that the side surface Sw of the outer peripheral wall 13w makes with an imaginary line drawn in the Q2 direction from the end portion in the Q2 direction of the adhesive region Ra. The angle θ6 that the side surface Sw of the outer peripheral wall 13w makes with an imaginary line drawn in the Q2 direction from the end portion in the Q2 direction of the adhesive region Ra is typically 90°.

Here, the adhesive 19 applied to any one surface has a property of flowing onto a surface that is more gently inclined when it flows onto a surface adjacent to that surface. This is because the surface with a more gentle inclination is closer to the adhesive 19. Therefore, since the acute angle θ1 that the first inclined portion Ci1_A makes with the T-axis is smaller than the angle θ2 that the side surface Sw of the outer peripheral wall 13w makes with an imaginary line drawn in the T2 direction from the end portion in the T2 direction of the adhesive region Ra, the adhesive 19 applied to the first adhesive region R1a is more likely to flow onto the first inclined portion Ci1_A than onto the side surface Sw of the outer peripheral wall 13w.

Furthermore, since the acute angle θ3 that the first inclined portion Ci1_B makes with the T-axis is smaller than the angle θ4 that the side surface Sb of the accommodation portion 13b makes with an imaginary line drawn in the T1 direction from the end portion in the T1 direction of the adhesive region Ra, the adhesive 19 applied to the first adhesive region R1a is more likely to flow onto the first inclined portion Ci1_B than onto the side surface Sb of the accommodation portion 13b.

Furthermore, since the acute angle θ5 that the second inclined portion Ci2 makes with the Q-axis is smaller than the angle θ6 that the side surface Sw of the outer peripheral wall 13w makes with an imaginary line drawn in the Q2 direction from the end portion in the Q2 direction of the adhesive region Ra, the adhesive 19 applied to the third adhesive region R3a is more likely to flow onto the second inclined portion Ci2 than onto the side surface Sw of the outer peripheral wall 13w.

Therefore, the adhesive 19 can be made to flow more easily into the first recess 13c_1 or the third recess 13c_3 than onto the side surface Sw of the outer peripheral wall 13w or the side surface Sb of the accommodation portion 13b.

Here, the following method, for example, can be considered as a scheme for making the distance Lr2 in the Z-axis direction between the second adhesive region R2a and the fixing plate 15 greater than the distance Lr1 in the Z-axis direction between the fixing plate 15 and the first adhesive region R1a. A first method is to cut the fixing plate 15, a second method is to cut the holder 13, and a third method is to cut both the holder 13 and the fixing plate 15.

These schemes are similar to the scheme for making the distance Lr2 in the Z-axis direction between the second adhesive region R2a and the fixing plate 15 greater than the distance Lr3 in the Z-axis direction between the fixing plate 15 and the third adhesive region R3a. The fixing plate 15 is thinner in the Z-axis direction than the holder 13, and cutting the fixing plate 15 reduces its strength. Therefore, out of the above three methods, the second method is preferred.

Here, as shown in FIG. 13, when viewed in the Z2 direction, the second surface 15f of the fixing plate 15 has a region 15R_1 that overlaps the first adhesive region R1a, a region 15R_2 that overlaps the second adhesive region R2a, and regions 15R_3 that overlap the third adhesive regions R3a. When the second method described above is employed, that is, when the fixing plate 15 is not cut, the thickness of the fixing plate 15 in the Z-axis direction is uniform. Therefore, in the fixing plate 15, the region 15R_1 that overlaps the first adhesive region R1a, the region 15R_2 that overlaps the second adhesive region R2a, and the regions 15R_3 that overlap the third adhesive regions R3a are all located at the same position in the Z-axis direction.

In addition, when the second method is employed, the holder 13 is cut, and thus the first adhesive region R1a is located further in the Z2 direction than the second adhesive region R2a, and the third adhesive region R3a is located further in the Z2 direction than the second adhesive region R2a. By employing this positional relationship, the distance Lr2 in the Z-axis direction between the second adhesive region R2a and the fixing plate 15 can be made greater than the distance Lr1 in the Z-axis direction between the first adhesive region R1a and the fixing plate 15, and the distance Lr3 in the Z-axis direction between the third adhesive region R3a and the fixing plate 15.

### 1-6. Modification Example

### 1-6-1. First Modification Example

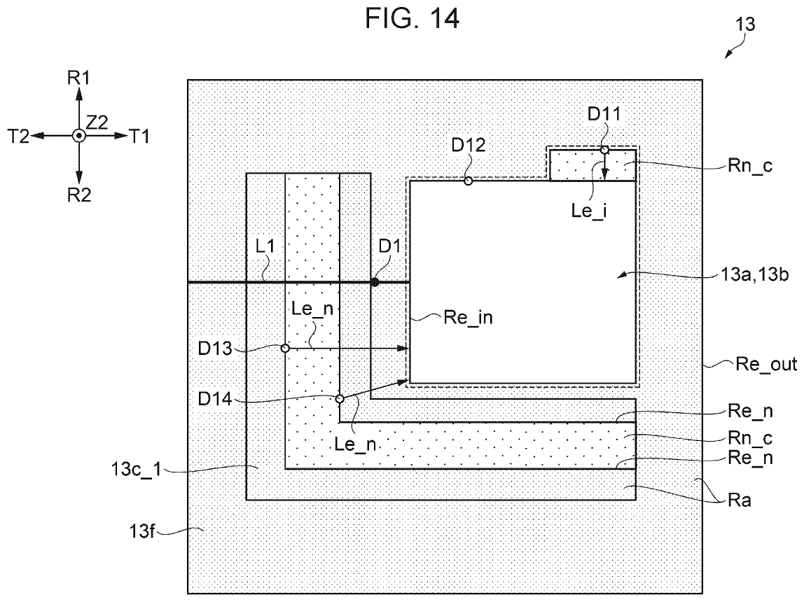

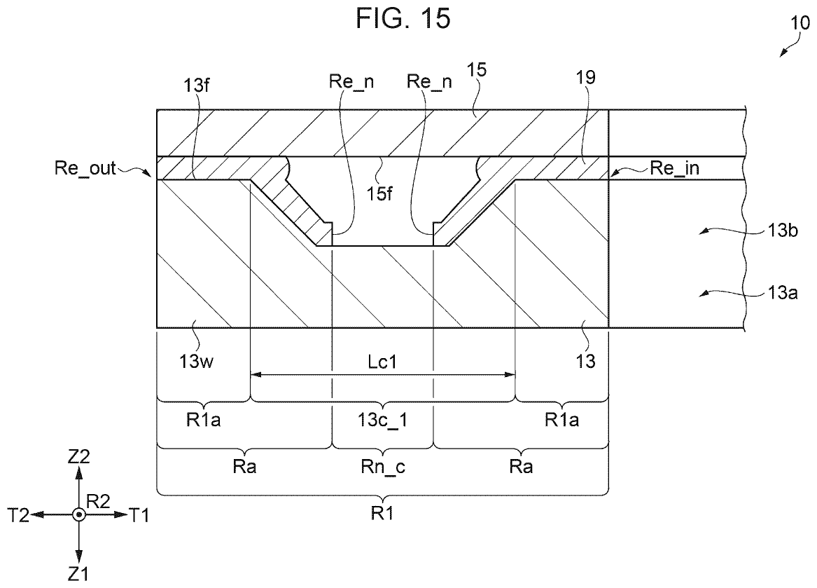

FIG. 14 is a view schematically showing a plan view of the holder 13 according to a first modification example when viewed in the Z1 direction. FIG. 15 is a cross-sectional view taken along a first line segment L1 of FIG. 14.

In the first modification example shown in FIGS. 14 and 15, the first surface 13f includes a non-adhesive region Rn_c with which the adhesive 19 is not in contact. In other words, the first surface 13f has a region that is not the adhesive region Ra. In the example shown in FIG. 14, one non-adhesive region Rn_c is provided inside the first recess 13c_1 and one non-adhesive region Rn_c is provided outside the first recess 13c_1.

The non-adhesive region Rn_c is represented by a sparse dot pattern, and the adhesive region Ra is represented by a dense dot pattern.

As shown in FIG. 14, the adhesive region Ra in the first modification example is annular when viewed in the Z1 direction, similarly to the above embodiment (see FIG. 6). That is, when viewed in the Z1 direction, the adhesive region Ra surrounds the wiring hole 13a and the accommodation portion 13b.

In the following, in the first modification example, the end portions of the adhesive region Ra that can be both ends of the first line segment L1, the second line segment L2, and the third line segment L3 will be described.

In the first modification example, one end portion of the adhesive region Ra is on the outer edge Re_out, and the other end portion is on an inner edge Re_in, which will be described later. That is, the first line segment L1 is between the outer edge Re_out and the inner edge Re_in. In FIG. 14, the inner edge Re_in is indicated by a broken line.

As described above, the outer edge Re_out is the outermost portion of the edge of the adhesive region Ra. On the other hand, the inner edge Re_in is an edge of the adhesive region Ra at which any point having the characteristics described below is located. When a shortest line segment Le_i is drawn from any point on the edge of the adhesive region Ra to the wiring hole 13a or the accommodation portion 13b, the line segment Le_i does not include the adhesive region Ra therebetween. However, the length of the shortest line segment Le_i may be zero. That is, the inner edge Re_in may coincide with the edge of the wiring hole 13a or the accommodation portion 13b.

For example, when the shortest line segment Le_i is drawn from a point D11 shown in FIG. 14 to the wiring hole 13a or the accommodation portion 13b, the line segment Le_i does not include the adhesive region Ra therebetween. Therefore, the point D11 is a point on the inner edge Re_in.

Also, a point D12 shown in FIG. 14 is on the edge of wiring hole 13a or the accommodation portion 13b.

In other words, when the shortest line segment Le_i is drawn from the point D12 to the wiring hole 13a or the accommodation portion 13b, the line segment Le_i has a length of zero and does not include the adhesive region Ra therebetween. Therefore, the point D12 is a point on the inner edge Re_in.

On the other hand, for example, when a shortest line segment Le_n is drawn from a point D13 and a point D14 shown in FIG. 14 to the wiring hole 13a or the accommodation portion 13b, the line segment Le_n includes the adhesive region Ra therebetween. Therefore, an edge Re_n on which the point D13 and the point D14 are located does not correspond to the inner edge Re_in.

Furthermore, the edge Re_n on which the point D13 and the point D14 are located does not correspond to the outer edge Re_out either. In other words, a point on the edge Re_n is not an end portion of the adhesive region Ra.

In FIG. 15, the inner edge Re_in is located at the end portion in the T1 direction of the first adhesive region R1a, which is located in the T1 direction, among the edges of the adhesive region Ra. The outer edge Re_out is located at the end portion in the T2 direction of the first adhesive region R1a, which is located in the T2 direction, among the edges of the adhesive region Ra. Among the edges of the adhesive region Ra, the edge Re_n that overlaps the first recess 13c_1 in the Z-axis direction does not correspond to an end portion of the adhesive region Ra.

### 1-6-2. Second Modification Example

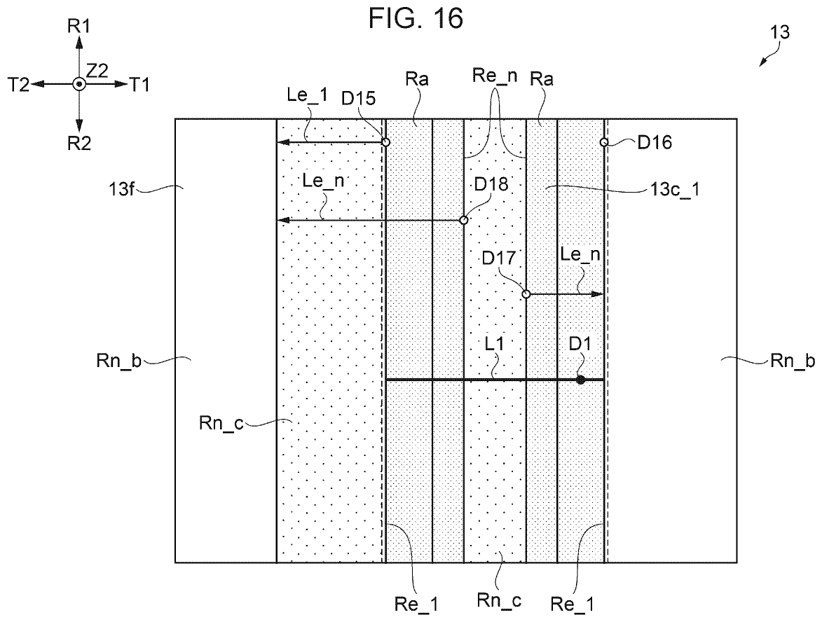

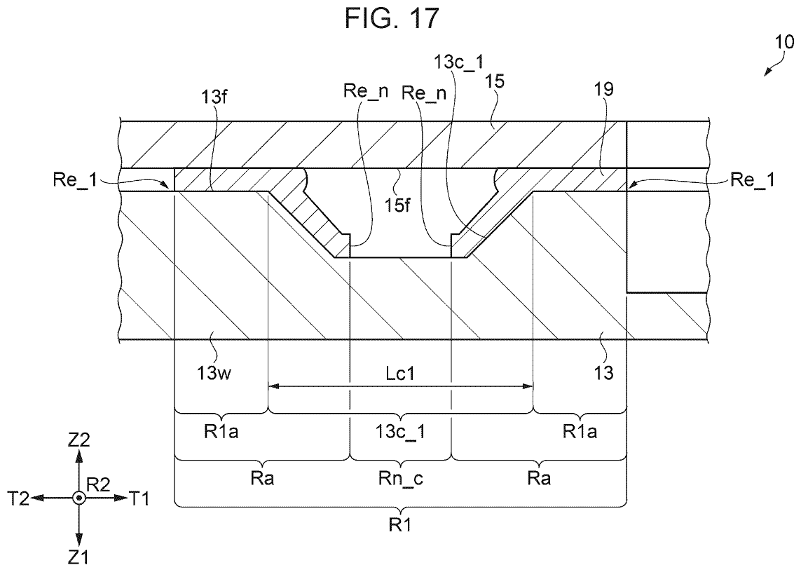

FIG. 16 is a view schematically showing a plan view of the holder 13 according to a second modification example when viewed in the Z1 direction. FIG. 17 is a cross-sectional view taken along a first line segment L1 of FIG. 16.

In the second modification example shown in FIGS. 16 and 17, a non-adhesive region Rn_c that is not in contact with the adhesive 19 is disposed on the first surface 13f. Moreover, when viewed in the Z1 direction, the adhesive region Ra is not annular but band-shaped. Specifically, two adhesive regions Ra extending in the R-axis direction are disposed in parallel on the first surface 13f.

Furthermore, in the second modification example, the first surface 13f is provided with protective regions Rn_b where the adhesive 19 is not desired to flow in the T1 direction and the T2 direction with respect to the adhesive region Ra. The protective regions Rn_b are, for example, the wiring hole 13a and the accommodation portion 13b.

In the following, in the second modification example, the end portions of the adhesive region Ra that can be both ends of the first line segment L1, the second line segment L2, and the third line segment L3 will be described.

In the second modification example, the end portion of the adhesive region Ra is on a first edge Re_1 to be described later. That is, the first line segment L1 is between the first edge Re_1 and the first edge Re_1. In FIG. 16, the first edge Re_1 is indicated by a broken line.

The first edge Re_1 is an edge of the adhesive region Ra at which any point having the characteristics described below is located. When a shortest line segment Le_1 is drawn from any point on the edge of the adhesive region Ra to the protective region Rn_b where the adhesive 19 is not desired to flow, the line segment Le_1 does not include the adhesive region Ra therebetween. However, the shortest line segment Le_1 drawn from the first edge Re_1 to the protective region Rn_b may have a length of zero. That is, the first edge Re_1 may coincide with the edge of the protective region Rn_b.

For example, when the shortest line segment Le_1 is drawn from a point D15 shown in FIG. 16 to the protective region Rn_b, the line segment Le_1 does not include the adhesive region Ra therebetween. Furthermore, a point D16 is located on the edge of the protective region Rn_b. Therefore, the edge on which the point D15 and the point D16 are located is the first edge Re_1.

Conversely, for example, when the shortest line segment Le_n is drawn from a point D17 and a point D18 to the protective region Rn_b, the line segment Le_n includes the adhesive region Ra therebetween. Therefore, the edge Re_n on which the point D17 and the point D18 are located does not correspond to the first edge Re_1. That is, a point on the edge Re_n is not an end portion of the adhesive region Ra.

In FIG. 17, the first edge Re_1 is located at the end portion in the T1 direction of the first adhesive region R1a located in the T1 direction among the edges of the adhesive region Ra, and at the end portion in the T2 direction of the first adhesive region R1a located in the T2 direction among the edges of the adhesive region Ra. Among the edges of the adhesive region Ra, the edge Re_n that overlaps the first recess 13c_1 in the Z-axis direction does not correspond to an end portion of the adhesive region Ra.

### 1-6-3. Third Modification Example

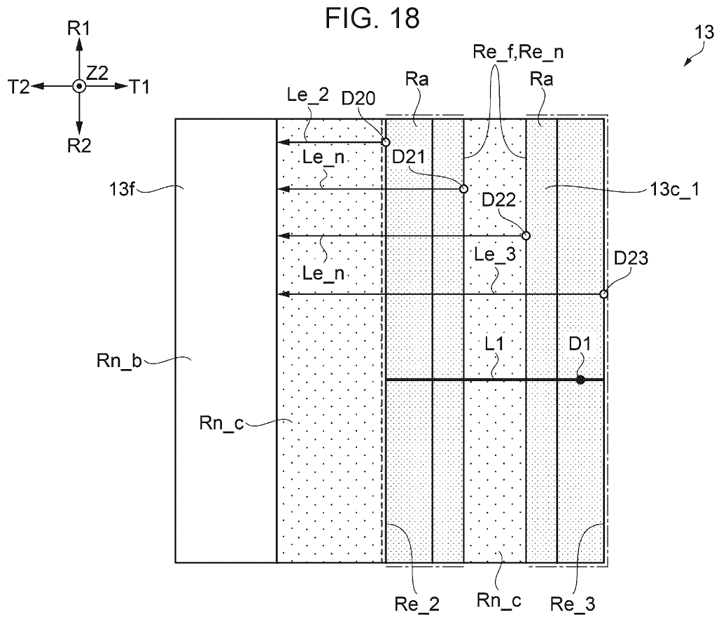

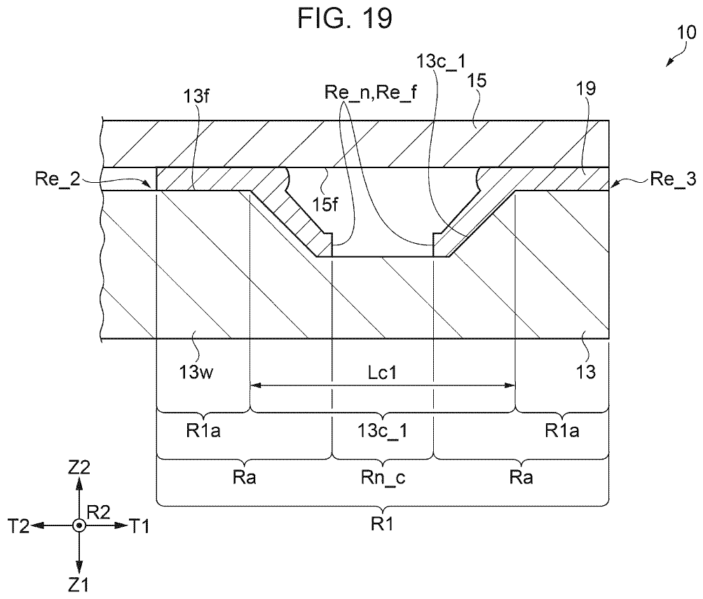

FIG. 18 is a view schematically showing a plan view of the holder 13 according to a third modification example when viewed in the Z1 direction. FIG. 19 is a cross-sectional view taken along a first line segment L1 of FIG. 18.

In the third modification example shown in FIG. 18, the adhesive region Ra is, similarly to the second modification example, band-shaped when viewed in the Z1 direction. Specifically, two adhesive regions Ra extending in the R-axis direction are disposed in parallel on the first surface 13f. Further, a protective region Rn_b where the adhesive 19 is not desired to flow is disposed in the T2 direction with respect to the adhesive region Ra, and a protective region Rn_b is not disposed in the T1 direction with respect to the adhesive region Ra. The protective regions Rn_b are, for example, the wiring hole 13a and the accommodation portion 13b.

Here, in the third modification example, the end portions of the adhesive region Ra that can be both ends of the first line segment L1, the second line segment L2, and the third line segment L3 will be described.

In the third modification example, one end portion of the adhesive region Ra is on a second edge Re_2 to be described later, and the other end portion of the adhesive region Ra is on a third edge Re_3 to be described later. That is, the first line segment L1 is between the second edge Re_2 and the third edge Re_3. In FIG. 18, the second edge Re_2 is indicated by a broken line, and the third edge Re_3 is indicated by a one-dot chain line.

The second edge Re_2 is an edge of the adhesive region Ra at which any point having the characteristics described below is located. When a shortest line segment Le_2 is drawn from any point on the edge of the adhesive region Ra to the protective region Rn_b where the adhesive 19 is not desired to flow, the line segment Le_2 does not include the adhesive region Ra therebetween.

However, the shortest line segment Le_2 drawn from the second edge Re_2 to the protective region Rn_b may have a length of zero. That is, the second edge Re_2 may coincide with the edge of the protective region Rn_b.

Here, when the edge of the adhesive region Ra and the edge of the adhesive region Ra face each other without interposing an adhesive region Ra therebetween, such edges of the adhesive regions Ra are referred to as facing edges Re_f.

The third edge Re_3 is an edge of the adhesive region Ra that is not the second edge Re_2 and is not the facing edge Re_f.

For example, when the shortest line segment Le_2 is drawn from a point D20 in FIG. 18 to the protective region Rn_b, the line segment Le_2 does not include the adhesive region Ra therebetween. Therefore, the edge on which the point D20 is located is the second edge Re_2.

Conversely, for example, when the shortest line segment Le_n is drawn from a point D21 and a point D22 to the protective region Rn_b, the line segment Le_n includes the adhesive region Ra therebetween. Therefore, the edge Re_n on which the point D21 and the point D22 are located does not correspond to the second edge Re_2.

Furthermore, the edge Re_n on which the point D21 and the point D22 are located is the facing edge Re_f. Therefore, the edge Re_n on which the point D21 and the point D22 are located does not correspond to the third edge Re_3 either.

That is, a point on the edge Re_n is not an end portion of the adhesive region Ra.

Furthermore, when a shortest line segment Le_3 is drawn from a point D23 to the protective region Rn_b, the line segment Le_3 includes the adhesive region Ra therebetween. Therefore, the edge on which the point D23 is located does not correspond to the second edge Re_2.

Furthermore, the edge on which the point D23 is located is not the facing edge Re_f. Therefore, the edge on which the point D23 is located is the third edge Re_3.

In FIG. 19, the second edge Re_2 is located at the end portion in the T2 direction of the first adhesive region R1a, which is located in the T2 direction, among the edges of the adhesive region Ra. The third edge Re_3 is located at the end portion in the T1 direction of the first adhesive region R1a, which is located in the T1 direction, among the edges of the adhesive region Ra. Among the edges of the adhesive region Ra, the edge Re_n that overlaps the first recess 13c_1 in the Z-axis direction is the facing edge Re_f, and does not correspond to an end portion of the adhesive region Ra.

### 1-6-4. Fourth Modification Example

As shown in a fourth modification example in FIG. 20, the second adhesive region R2a may have a second recess 13c_2. That is, the second adhesive region R2a may be a folded line in which a plurality of line segments are continuously coupled, or may be a curved line.

However, a length Lc2 of the second recess 13c_2 in the U-axis direction is smaller than the length Lc1 of the first recess 13c_1 in the T-axis direction shown in FIG. 10. In addition, the length Lc2 of the second recess 13c_2 in the U-axis direction is smaller than the length Lc3 of the third recess 13c_3 in the Q-axis direction shown in FIG. 12. That is, the second adhesive region R2a does not have a recess whose length in the U-axis direction is equal to or greater than the length Lc1 of the first recess 13c_1 in the T-axis direction. Furthermore, the second adhesive region R2a does not have a recess whose length in the U-axis direction is equal to or greater than the length Lc3 of the third recess 13c_3 in the Q-axis direction.

In other words, the second adhesive region R2a may have the second recess 13c_2 that is smaller than the length Lc1 of the first recess 13c_1 in the T-axis direction and the length Lc3 of the third recess 13c_3 in the Q-axis direction.

### 1-6-5. Fifth Modification Example

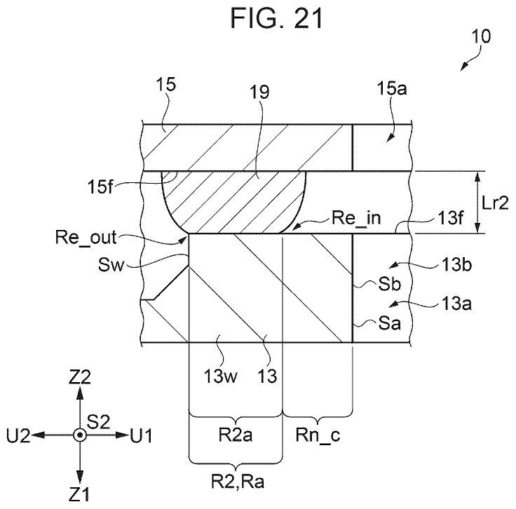

In a fifth modification example shown in FIG. 21, the first surface 13f has a non-adhesive region Rn_c that is not in contact with the adhesive 19 and is aligned in the same straight line as the second adhesive region R2a. As described above, the second adhesive region R2a is a region where the distance Lr2 in the Z-axis direction from the fixing plate 15 is greater than the distance Lr1 in the Z-axis direction between the fixing plate 15 and the first adhesive region R1a, and the distance Lr3 in the Z-axis direction between the fixing plate 15 and the third adhesive region R3a.

In the fifth modification example, the sum of the length of the second adhesive region R2a in the U-axis direction and the length of the non-adhesive region Rn_c in the U-axis direction is smaller than the length of the third line segment L3 described above. In other words, the sum of the length of the second line segment L2 and the length of the non-adhesive region Rn_c in the U-axis direction is smaller than the length of the third line segment L3.

In other words, when the length in the U-axis direction of a certain region of the first surface 13f is smaller than the third line segment L3, the region may have a non-adhesive region Rn_c in addition to the second adhesive region R2a.

Here, it is assumed that the length obtained by adding the length of the second line segment L2 and the length of the non-adhesive region Rn_c in the U-axis direction is greater than the length of the third line segment L3.

In this case, the length in the U-axis direction of the region where the second adhesive region R2a and the non-adhesive region Rn_c are provided is large enough to provide the third recess 13c_3 and the third adhesive region R3a.

Nevertheless, the third adhesive region R3a and the third recess 13c_3 are not provided in the region, but the second adhesive region R2a and the non-adhesive region Rn_c are provided.

In such a mode, since the thickness of the adhesive 19 in the Z-axis direction of the second adhesive region R2a is greater than the thickness of the adhesive 19 in the Z-axis direction of the third adhesive region R3a, there is a concern that the adhesive strength may decrease.

The above case also includes a case where the length in the U-axis direction of the region where the second adhesive region R2a and the non-adhesive region Rn_c are provided is large enough to provide the first recess 13c_1 and two first adhesive regions R1a. Nevertheless, the first recess 13c_1 and the two first adhesive regions R1a are not provided in the region, but the second adhesive region R2a and the non-adhesive region Rn_c are provided.

Similarly, in such a mode, since the thickness of the adhesive 19 in the Z-axis direction of the second adhesive region R2a is greater than the thickness of the adhesive 19 in the Z-axis direction of the first adhesive region R1a, there is a concern that the adhesive strength may decrease.

On the other hand, in the fifth modification example, only when the length in the U-axis direction of a certain region of the first surface 13f is smaller than the third line segment L3, the second adhesive region R2a and the non-adhesive region Rn_c are provided in the region. When the length in the U-axis direction of the region is greater than the third line segment L3, the second adhesive region R2a and the non-adhesive region Rn_c are not provided in the region. Therefore, it is possible to suppress the adhesive 19 from overflowing while suppressing a decrease in adhesive strength.

### 1-6-6. Sixth Modification Example

In the present embodiment described above, the holder 13 has the first surface 13f, the adhesive region Ra, the first adhesive region R1a, the second adhesive region R2a, the first recess 13c_1, and the like. However, these configurations may not be provided in the holder 13 but may be provided in the fixing plate 15.

Furthermore, the position where the aforementioned configuration is provided is not limited to the adhesive portion between the holder 13 and the fixing plate 15. For example, when the holder 13 is separated into a plurality of holders, the aforementioned configuration may be provided at the adhesive portions between the plurality of holders. Also, for example, the aforementioned configuration may be provided on the adhesive portion of each element of the head chip 14.

### 2. Second Embodiment

### 2-1. Regarding Adhesive Portion of Flow Path Member

The first embodiment described above is a configuration related to the adhesive portion between the holder 13 and the fixing plate 15, but a second embodiment is a configuration related to an adhesive portion between a first flow path member 70 and a second flow path member 80, which are members that form the flow paths of the liquid ejecting head 10. The first flow path member 70 is, for example, the aforementioned flow path substrate 14a, and the second flow path member 80 is, for example, the aforementioned case 14h.

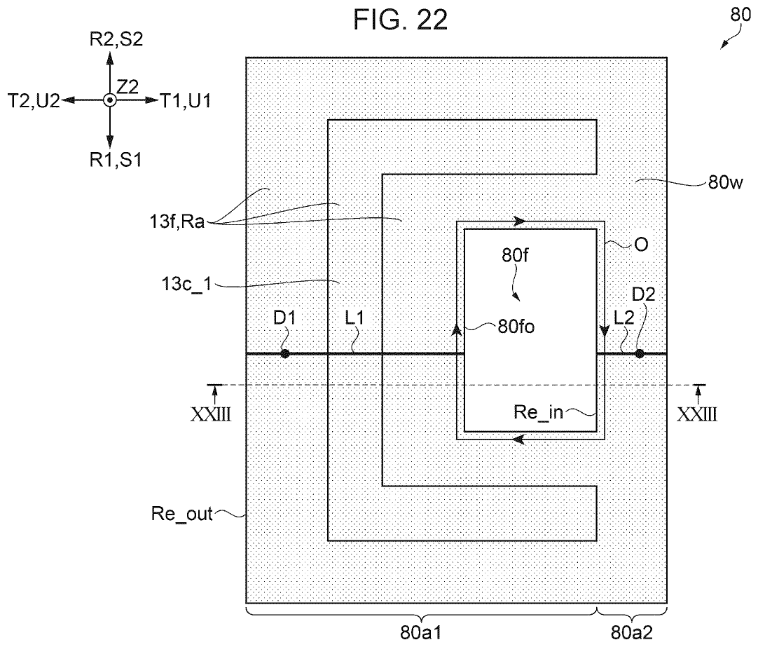

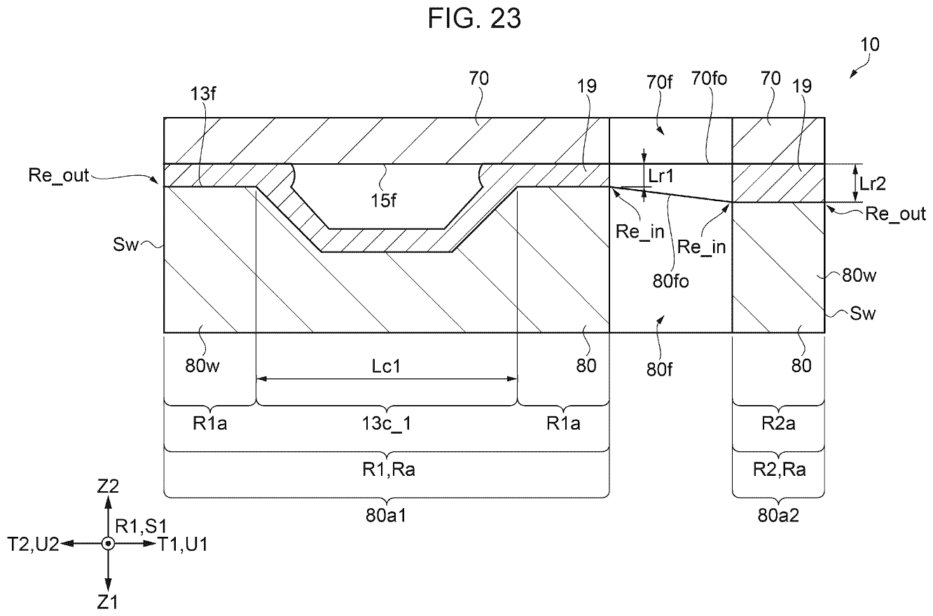

FIG. 22 is a plan view of the second flow path member 80 as viewed in the Z1 direction. FIG. 23 is a cross-sectional view taken along line XXIII-XXIII in FIG. 22 in the R2 direction. FIG. 23 shows the first flow path member 70 in addition to the second flow path member 80. The same components as those in the first embodiment are denoted by the same reference numerals, and duplicated descriptions will be omitted. In the present embodiment, the first line segment L1 and the second line segment L2 are parallel to each other. In other words, the T-axis direction is equal to the U-axis direction, and the R-axis direction is equal to the S-axis direction.

As shown in FIG. 23, the first flow path member 70 has a first flow path 70f which is a through hole penetrating the first flow path member 70 in the Z-axis direction, and a second surface 15f which is a surface facing the Z1 direction. The second surface 15f has an opening 70fo that defines the first flow path 70f.

The second flow path member 80 is stacked on the first flow path member 70 in the Z1 direction. As shown in FIGS. 22 and 23, the second flow path member 80 has a second flow path 80f which is a through hole penetrating the second flow path member 80 in the Z-axis direction, and a wall 80w that defines the second flow path 80f. The wall 80w has a first surface 13f that faces the Z2 direction. The first surface 13f has an opening 80fo that defines the second flow path 80f.

A liquid flows through the first flow path 70f and the second flow path 80f. As shown in FIG. 23, the second surface 15f of the first flow path member 70 and the first surface 13f of the second flow path member 80 are adhered together with the adhesive 19, thereby communicating the first flow path 70f and the second flow path 80f.

The first surface 13f has the adhesive region Ra where the adhesive 19 is applied. In the present embodiment, the entire area of the first surface 13f is the adhesive region Ra, but the first surface 13f may have a region that is not the adhesive region Ra.

As shown in FIG. 22, the adhesive region Ra annularly surrounds the entire periphery of the opening 80fo of the second flow path 80f when viewed in the Z1 direction. Therefore, the opening 70fo of the first flow path 70f, the adhesive 19, and the opening 80fo of the second flow path 80f are stacked without any gaps. In other words, the opening 70fo of the first flow path 70f and the opening 80fo of the second flow path 80f are tightly coupled by the adhesive 19.

Here, the direction along the opening 80fo of the second flow path 80f is referred to as a circumferential direction O. The circumferential direction O is perpendicular to the Z-axis direction. In FIG. 22, the circumferential direction O at a point where the first line segment L1 and the opening 80fo of the second flow path 80f intersect is equal to the R-axis direction and the S-axis direction. Similarly, the circumferential direction O at a point where the second line segment L2 and the opening 80fo of the second flow path 80f intersect is equal to the R-axis direction and the S-axis direction.

The wall 80w that defines the second flow path 80f has a first portion 80al and a second portion 80a2. In the cross section taken along line XXIII-XXIII, the width of the second portion 80a2 in the U-axis direction is smaller than the width of the first portion 80al in the T-axis direction. That is, the width of the second portion 80a2 in a direction orthogonal to the circumferential direction O and the Z-axis direction is smaller than the width of the first portion 80al in a direction orthogonal to the circumferential direction O and the Z-axis direction.

The first surface 13f of the first portion 80al corresponds to the region RL1 (see FIG. 7) in which the first line segment L1 can be drawn. That is, the first surface 13f of the first portion 80al has two first adhesive regions R1a and a first recess 13c_1.

The first surface 13f of the second portion 80a2 corresponds to the region RL2 (see FIG. 7) in which the second line segment L2 can be drawn. That is, the first surface 13f of the second portion 80a2 has a second adhesive region R2a.

The wall 80w that defines the second flow path 80f may have a third portion. The third portion is a portion in which a width in a direction orthogonal to the circumferential direction O and the Z-axis direction that is smaller than the width of the first portion 80al in a direction orthogonal to the circumferential direction O and the Z-axis direction, and is greater than the width of the second portion 80a2 in a direction orthogonal to the circumferential direction O and the Z-axis direction.

In this case, the first surface 13f of the third portion is the region RL3 in which the third line segment L3 can be drawn. That is, the first surface 13f of the third portion 80a3 has a third adhesive region R3a and a third recess 13c_3.

### 3. Regarding Wording of Claims

In the first embodiment and the second embodiment, either the Z1 direction or the Z2 direction is an example of a “first direction”.

Also, the U-axis direction is an example of a “direction along the second line segment L2”.

Further, the T-axis direction is an example of a “direction along the first line segment”, the T1 direction is either “one side of the direction along the first line segment” or “another side of the direction along the first line segment”, and the T2 direction is either “another side of the direction along the first line segment” or “one side of the direction along the first line segment”.

In the first embodiment, the fixing plate 15 or the holder 13 is an example of a “first member”, and the fixing plate 15 or the holder 13 is an example of a “second member”. Here, when the fixing plate 15 is the “first member” and the holder 13 is the “second member”, the Z1 direction is the “first direction” and the Z2 direction is a “direction opposite to the first direction”. On the other hand, when the fixing plate 15 is the “second member” and the holder 13 is the “first member”, the Z2 direction is the “first direction” and the Z1 direction is a “direction opposite to the first direction”.

In the second embodiment, the first flow path member 70 is an example of the “first member”, and the second flow path member 80 is an example of the “second member”. Moreover, the first portion 80al or the third portion is an example of a “first portion”.

In the first embodiment and the second embodiment, the first point D1 and the third point D3 are examples of a “first point”, the first line segment L1 and the third line segment L3 are examples of a “first line segment”, the first adhesive regions R1a and the third adhesive region R3a are examples of “first adhesive region”, and further, the first recess 13c_1 and the third recess 13c_3 are examples of a “first recess”. The “first adhesive region” is a general term for the multiple first adhesive regions R1a and the third adhesive region R3a.

In addition, the first inclined portion Ci1 and the second inclined portion Ci2 are examples of an “inclined portion”.

Furthermore, the region 15R_1 that overlaps the first adhesive region R1a and the regions 15R_3 that overlap the third adhesive regions R3a are examples of “regions that overlaps the first adhesive regions”.

Furthermore, the liquid ejecting module 40 is an example of a “head unit”, and the X-axis direction is an example of an “arrangement direction”.

### 4. Summary

### 4-1. Summary of First Embodiment

The liquid ejecting head 10 according to the first embodiment will be described below.

The liquid ejecting head 10 has a fixing plate 15, a holder 13 stacked in the Z1 direction on the fixing plate 15 and having a first surface 13f, and an adhesive 19 that adheres the fixing plate 15 to the first surface 13f. The first surface 13f has an adhesive region Ra in contact with the adhesive 19. When viewed in the Z1 direction, a first line segment L1 that passes through a first point D1 in the adhesive region Ra and connects end portions of the adhesive region Ra at the shortest distance and a third line segment L3 that passes through a third point D3 in the adhesive region Ra and connects the end portions of the adhesive region Ra at the shortest distance are longer than a second line segment L2 that passes through a second point D2 different from the first point D1 and the third point D3 in the adhesive region Ra and connects the end portions of the adhesive region Ra at the shortest distance. A region R1 of the first surface 13f that overlaps the first line segment L1 in the Z1 direction has first adhesive regions R1a that are portions of the adhesive region Ra and a first recess 13c_1 that is recessed in the Z1 direction further than the first adhesive regions R1a. A region R3 of the first surface 13f that overlaps the third line segment L3 in the Z1 direction has a third adhesive region R3a which is a portion of the adhesive region Ra and a third recess 13c_3 that is recessed in the Z1 direction further than the third adhesive region R3a. A second adhesive region R2a of the adhesive region Ra that overlaps the second line segment L2 in the Z1 direction has a distance Lr2 in the Z-axis direction from the fixing plate 15 that is greater than a distance Lr1 in the Z-axis direction between the fixing plate 15 and the first adhesive region R1a and a distance Lr3 in the Z-axis direction between the fixing plate 15 and the third adhesive region R3a, does not have a recess whose length in the U-axis direction, which is a direction along the second line segment L2, is equal to or greater than the length Lc1 of the first recess 13c_1 in the T-axis direction, and does not have a recess whose length in the U-axis direction is equal to or greater than the length Lc3 of the third recess 13c_3 in the Q-axis direction.

In the liquid ejecting head 10, it is desirable to suppress excess adhesive 19 from overflowing outside the adhesive region where the holder 13 and the fixing plate 15 are adhered. Therefore, by providing recesses, such as, for example, the first recess 13c_1 and the third recess 13c_3, in the holder 13 or the fixing plate 15 to cause the excess adhesive 19 to flow therein, it is possible to suppress the adhesive 19 from overflowing. However, in some cases, a portion of the holder 13 or the fixing plate 15 has a narrow width of the adhesive region Ra, and no recess is provided for causing the excess adhesive 19 to flow therein. For example, it is necessary to perform adhesion even in a portion having a narrow width in the U-axis direction, such as the region RL2 in which the second line segment L2 can be drawn.

On the other hand, instead of providing a recess, the adhesive 19 can also be suppressed from overflowing by increasing the distance between the fixing plate 15 and the holder 13. However, since the thickness of the adhesive 19 increases, there is a concern that the adhesive strength may decrease. In other words, when the thickness of the adhesive 19 is increased not only in the region RL2 in which the second line segment L2 can be drawn, but also in the region RL1 in which the first line segment L1 can be drawn and the region RL3 in which the third line segment L3 can be drawn, the strength of adhesion decreases.

According to the liquid ejecting head 10, the first recess 13c_1 is provided in the region R1 of the first surface 13f that overlaps the first line segment L1 in the Z1 direction. This causes excess adhesive 19 to flow into the first recess 13c_1, making it possible to suppress the adhesive 19 from overflowing to other locations. Similarly, the third recess 13c_3 is provided in a region R3 of the first surface 13f that overlaps the third line segment L3 in the Z1 direction. This causes excess adhesive 19 to flow into the third recess 13c_3, making it possible to suppress the adhesive 19 from overflowing to other locations.

The width of the region R2 of the first surface 13f that overlaps the second line segment L2 in the Z1 direction is so narrow that it is not possible to provide a recess whose length in the U-axis direction is equal to or greater than the length Lc1 of the first recess 13c_1 in the T-axis direction. Moreover, the width of the region R2 is so narrow that it is not possible to provide a recess whose length in the U-axis direction is equal to or greater than the length Lc3 of the third recess 13c_3 in the Q-axis direction. In the region R2 that overlaps the second line segment L2 having a narrow width in the Z1 direction, the adhesive 19 can be suppressed from overflowing by increasing the distance Lr2 in the Z-axis direction between the fixing plate 15 and the holder 13.

In other words, in the narrow region, the distance in the Z-axis direction between the holder 13 and the fixing plate 15 is made large, and in the wide region, a recess is provided without making the distance in the Z-axis direction between the holder 13 and the fixing plate 15 large. Therefore, even when a portion of the adhesive region Ra includes a narrow portion, it is possible to suppress the adhesive 19 from overflowing while minimizing the decrease in strength.

When viewed in the Z-axis direction, the first recess 13c_1 has at least one of a first inclined portion Ci1_A and a first inclined portion Ci1_B, which will be described later. The first inclined portion Ci1_A is provided in the first recess 13c_1 located in the T1 direction with respect to the first adhesive region R1a when viewed in the Z-axis direction, is adjacent to the first adhesive region R1a, and extends along a direction that is a combination of the T1 direction and the Z1 direction. The first inclined portion Ci1_B is provided in the first recess 13c_1 located in the T2 direction with respect to the first adhesive region R1a when viewed in the Z-axis direction, is adjacent to the first adhesive region R1a, and extends along a direction that is a combination of the T2 direction and the Z1 direction.

When viewed in the Z-axis direction, when the third recess 13c_3 is located in the Q1 direction with respect to the third adhesive region R3a, the third recess 13c_3 is adjacent to the third adhesive region R3a and has a second inclined portion Ci2 along a direction that is a combination of the Q1 direction and the Z1 direction. When viewed in the Z-axis direction, when the third recess 13c_3 is located in the Q2 direction with respect to the third adhesive region R3a, the third recess 13c_3 is adjacent to the third adhesive region R3a and has a second inclined portion Ci2 along a direction that is a combination of the Q2 direction and the Z1 direction.

The first recess 13c_1 has a first inclined portion Ci1 adjacent to the first adhesive region R1a, and the third recess 13c_3 has a second inclined portion Ci2 adjacent to the third adhesive region R3a. Therefore, compared to when the first inclined portion Ci1 or the second inclined portion Ci2 is not provided, the distance between the adhesive 19 and the first recess 13c_1 or the third recess 13c_3 is closer, and thus the excess adhesive 19 is more likely to flow from the first adhesive region R1a to the first inclined portion Ci1, or from the third adhesive region R3a to the second inclined portion Ci2.

The first adhesive regions R1a are disposed on both ends of the first recess 13c_1 in the T-axis direction.

This makes it possible to suppress excess adhesive 19 that has flowed from the first adhesive region R1a into the first recess 13c_1 from overflowing further from the first recess 13c_1, compared to when the first adhesive region R1a is disposed in either the T1 direction or the T2 direction of the first recess 13c_1. For example, when the first adhesive region R1a is disposed in the T1 direction of the first recess 13c_1, compared to when the first adhesive region R1a is not disposed in the T2 direction of the first recess 13c_1, excess adhesive 19 that has flowed from the first adhesive region R1a into the first recess 13c_1 can be suppressed from overflowing beyond the first recess 13c_1 in the T2 direction.

Further, since the first adhesive regions R1a are disposed on both ends in the T-axis direction of the non-adhesive region included in the first recess 13c_1, the strength of adhesion is increased.

The adhesive 19 disposed in the first adhesive regions R1a and the second adhesive region R2a is in contact with the fixing plate 15, and at least a portion of the adhesive 19 disposed in the first recess 13c_1 and the third recess 13c_3 is not in contact with the fixing plate 15.

This causes excess adhesive 19 to flow into the first recess 13c_1 or the third recess 13c_3, compared to when the adhesive 19 disposed in the first recess 13c_1 or the third recess 13c_3 does not have a portion not in contact with the fixing plate 15. Therefore, it is possible to suppress excess adhesive 19 from overflowing to the outside of the region R1 of the first surface 13f that overlaps the first line segment L1 in the Z1 direction.

The width Lc1 of the first recess 13c_1 in the T-axis direction is greater than the length of the second line segment L2. In addition, the width Lc3 of the third recess 13c_3 in the Q-axis direction is greater than the length of the second line segment L2.

In other words, the width of the second adhesive region R2a in the U-axis direction is smaller than the width Lc1 of the first recess 13c_1 in the T-axis direction. Even in such a case, by making the distance Lr2 between the second adhesive region R2a and the fixing plate 15 greater than the distance Lr1 between the first adhesive region R1a and the fixing plate 15, it is possible to suppress excess adhesive 19 from overflowing outside the second adhesive region R2a.

Further, the width of the second adhesive region R2a in the U-axis direction is smaller than the width Lc3 of the third recess 13c_3 in the Q-axis direction. Even in such a case, by making the distance Lr2 between the second adhesive region R2a and the fixing plate 15 greater than the distance Lr3 between the third adhesive region R1a and the fixing plate 15, it is possible to suppress excess adhesive 19 from overflowing outside the second adhesive region R2a.

The second adhesive region R2a is linear when viewed in a direction orthogonal to the Z1 direction and the second line segment L2.

The fixing plate 15 is a fixing plate 15 to which a head chip 14 is fixed, in which the head chip 14 ejects a liquid in the Z2 direction from the plurality of nozzles N arranged in the V-axis direction intersecting the Z-axis direction, and the fixing plate 15 has an exposure opening portion 15a that exposes the plurality of nozzles N, and the holder 13 is a holder 13 that accommodates the head chip 14.

Since the fixing plate 15 has exposure opening portions 15a that expose the plurality of nozzles N that eject a liquid, the liquid is easily adhered to the fixing plate 15. When the excess adhesive 19 overflows from the adhesive region Ra, the overflowing adhesive 19 is more likely to come into contact with a liquid. When the adhesive 19 comes into contact with a liquid, it swells. Therefore, when the adhesive 19 disposed in the adhesive region Ra swells, the adhesion between the holder 13 and the fixing plate 15 may be destroyed, and there is a concern that the holder 13 and the fixing plate 15 may peel off.

By making it possible to suppress the adhesive 19 from overflowing, it is possible to suppress the holder 13 and the fixing plate 15 from peeling off from each other.

A region 15R_2 of the second surface 15f of the fixing plate 15 facing the holder 13 that overlaps the second adhesive region R2a when viewed in the Z2 direction, and a region 15R_1 of the second surface 15f that overlaps the first adhesive region R1a when viewed in the Z2 direction or a region 15R_3 of the second surface 15f that overlaps the third adhesive region R3a when viewed in the Z2 direction are at the same position in the Z-axis direction.

As a scheme for making the distance Lr2 in the Z-axis direction between the second adhesive region R2a and the fixing plate 15 greater than the distance Lr1 in the Z-axis direction between the fixing plate 15 and the first adhesive region R1a, for example, first a method of cutting the fixing plate 15, second a method of cutting the holder 13, and third a method of cutting both the holder 13 and the fixing plate 15 can be considered. Here, the fixing plate 15 is thinner in the Z-axis direction than the holder 13. Therefore, in the first and third methods, since the fixing plate 15 is cut, which is thin, there is a concern that the strength of the fixing plate 15 may decrease. On the other hand, in the second method, the holder 13 is cut but the fixing plate 15, which is thin, is not cut, so that it is possible to suppress the strength of the fixing plate 15 from decreasing.

Since the fixing plate 15 is not cut, the thickness of the fixing plate 15 is uniform, and the region 15R_1, the region 15R_2, and the region 15R_3 are at the same position in the Z-axis direction.

The third adhesive region R3a is disposed in the Q1 direction of the third recess 13c_3 and is not disposed in the Q2 direction of the third recess 13c_3, or the third adhesive region R3a is disposed in the Q2 direction of the third recess 13c_3 and is not disposed in the Q1 direction of the third recess 13c_3.

There are cases where the width of the first surface 13f in the Q-axis direction is so small that the third adhesive regions R3a cannot be provided at both ends of the third recess 13c_3 in the Q-axis direction. Even in this case, the third adhesive region R3a is provided at one end of the third recess 13c_3 in the Q-axis direction, and the distance between the fixing plate 15 and the holder 13 is not large. Therefore, since the adhesive 19 flows into the third recess 13c_3 while minimizing the reduction in strength, it is possible to suppress the adhesive 19 from overflowing in the Q-axis direction of the third adhesive region R3a in a direction in which the third recess 13c_3 is not disposed.

The plurality of liquid ejecting heads 10 are arranged in the X-axis direction, which is an arrangement direction, to form a liquid ejecting module 40, and the holder 13 has an outer peripheral wall 13w that surrounds the head chip 14 when viewed in the Z-axis direction, and the second adhesive region R2a is located at the end portion of the outer peripheral wall 13w in the X-axis direction.

In order to arrange the nozzles N at a high density, it is necessary to reduce the width in the X-axis direction at the end portion of the outer peripheral wall 13w of the holder 13 in the X-axis direction, which is the arrangement direction. Therefore, by providing the second adhesive region R2a in this portion, it is possible to suppress the adhesive 19 from overflowing.

### 4-2. Summary of Second Embodiment

The liquid ejecting head 10 according to the second embodiment will be described below.

In the liquid ejecting head 10, the first flow path member 70 has a first flow path 70f through which a liquid flows, and the second flow path member 80 has a second flow path 80f through which a liquid flows, an opening 70fo of the first flow path and an opening 80fo of the second flow path are tightly coupled by an adhesive 19, an adhesive region Ra annularly surrounds the entire periphery of the opening 80fo of the second flow path when viewed in the Z1 direction, a wall 80w that defines the second flow path 80f of the second flow path member 80 includes a first portion 80a1 or a third portion and a second portion 80a2 whose width in a direction orthogonal to both the circumferential direction O of the opening 80fo and the Z1 direction is smaller than the width of the first portion 80al in the direction orthogonal to both the circumferential direction O and the Z1 direction or the width of the third portion in the direction orthogonal to both the circumferential direction O and the Z1 direction, the first portion 80al has first adhesive regions R1a and a first recess 13c_1, the third portion has a third adhesive region R3a and a third recess 13c_3, and the second portion 80a2 has a second adhesive region R2a.

When the first flow path member 70 and the second flow path member 80 are adhered together, in a case where the adhesive 19 overflows into the first flow path 70f and the second flow path 80f, there is a concern that the overflowing adhesive 19 may block the first flow path 70f and the second flow path 80f. In addition, there is a concern that air bubbles contained in the liquid flowing through the first flow path 70f and the second flow path 80f may be retained in the overflowing adhesive 19.

In order to suppress the adhesive 19 from overflowing, when the distance in the Z-axis direction between the first flow path member 70 and the second flow path member 80 is increased, the area of the adhesive 19 in contact with the liquid flowing through the first flow path 70f and the second flow path 80f becomes larger, and the adhesive 19 is easily eroded by the liquid. Therefore, it is desirable that the distance in the Z-axis direction between the first flow path member 70 and the second flow path member 80 is small.

Therefore, the first portion 80al is provided with the first adhesive regions R1a and the recess 13c_1. Furthermore, the second adhesive region R2a is provided in the second portion 80a2, which has a smaller width in the direction intersecting the circumferential direction O and the Z-axis direction than the first portion 80a1, in which the distance in the Z-axis direction between the first flow path member 70 and the second flow path member 80 is greater than those in the first adhesive regions R1a. That is, when the adhesive region Ra includes a narrow portion, the distance in the Z-axis direction between the first flow path member 70 and the second flow path member 80 is increased in the narrow portion, and the distance in the Z-axis direction between the first flow path member 70 and the second flow path member 80 is not increased in the wide portion. Therefore, it is possible to suppress the adhesive 19 from overflowing while minimizing erosion of the adhesive 19 by the liquid.

Therefore, it is possible to suppress the overflowing adhesive 19 from blocking the first flow path 70f and the second flow path 80f, and to suppress air bubbles from being retained in the overflowing adhesive 19.

What is claimed is:

1. A liquid ejecting head comprising:
a first member;
a second member stacked in a first direction on the first member and having a first surface; and
an adhesive that adheres the first member to the first surface, wherein
the first surface has an adhesive region in contact with the adhesive,
when viewed in the first direction, a first line segment that passes through a first point in the adhesive region and that connects end portions of the adhesive region at a shortest distance is longer than a second line segment that passes through a second point different from the first point in the adhesive region and that connects the end portions of the adhesive region at the shortest distance,
a region of the first surface that overlaps the first line segment in the first direction has a first adhesive region that is portion of the adhesive region and a first recess that is recessed in the first direction further than the first adhesive region, and
a second adhesive region of the adhesive region that overlaps the second line segment in the first direction has a distance in the first direction from the first member that is greater than a distance in the first direction between the first member and the first adhesive region, and does not have a recess whose length in a direction along the second line segment is equal to or greater than a length of the first recess in a direction along the first line segment.

2. The liquid ejecting head according to claim 1, wherein,
when viewed in the first direction, the first recess is located on one side of the direction along the first line segment with respect to the first adhesive region, and
the first recess has an inclined portion that is adjacent to the first adhesive region and that extends along a direction that is a combination of the first direction and the one side of the direction along the first line segment.

3. The liquid ejecting head according to claim 1, wherein
the first adhesive region is disposed on both ends of the first recess in the direction along the first line segment.

4. The liquid ejecting head according to claim 1, wherein
the adhesive disposed in the first adhesive region and the second adhesive region is in contact with the first member, and
at least a portion of the adhesive disposed in the first recess is not in contact with the first member.

5. The liquid ejecting head according to claim 1, wherein
a width of the first recess in the direction along the first line segment is greater than a length of the second line segment.

6. The liquid ejecting head according to claim 1, wherein
the second adhesive region is linear when viewed in a direction orthogonal to the first direction and the second line segment.

7. The liquid ejecting head according to claim 1, wherein
the first member is a fixing plate to which a head chip is fixed, the head chip ejecting a liquid in a direction opposite to the first direction from a plurality of nozzles arranged in a direction intersecting the first direction, the fixing plate having an opening portion that exposes the plurality of nozzles, and
the second member is a holder that accommodates the head chip.

8. The liquid ejecting head according to claim 7, wherein
a region of a second surface of the fixing plate facing the holder that overlaps the second adhesive region when viewed in the direction opposite to the first direction and a region of the second surface that overlaps the first adhesive region when viewed in the direction opposite to the first direction are at the same position in the first direction.

9. The liquid ejecting head according to claim 1, wherein
the first member has a first flow path through which a liquid flows,
the second member has a second flow path through which a liquid flows,
an opening of the first flow path and an opening of the second flow path are tightly coupled by the adhesive,
the adhesive region annularly surrounds an entire periphery of the opening of the second flow path when viewed in the first direction,
a wall that defines the second flow path of the second member includes a first portion and a second portion whose width in a direction orthogonal to both a circumferential direction of the opening and the first direction is smaller than a width of the first portion in the direction orthogonal to both the circumferential direction and the first direction,
the first portion has the first adhesive region and the first recess, and
the second portion has the second adhesive region.

10. The liquid ejecting head according to claim 1, wherein
the first adhesive region is disposed on one side of the first recess in the direction along the first line segment, and is not disposed on another side of the first recess in the direction along the first line segment.

11. The liquid ejecting head according to claim 7, wherein
the liquid ejecting head is one of a plurality of liquid ejecting heads arranged in an arrangement direction to form a head unit,
the holder has an outer peripheral wall that surrounds the head chip when viewed in the first direction, and
the second adhesive region is located at an end portion of the outer peripheral wall in the arrangement direction.
